(19) United States
(12) Patent Application Publication
(10) Pub. No.: US 2002/0002425 A1
(43) Pub. Date: Jan. 3, 2002

(54) Computer controlled irrigation and environment management system

(76) Inventors: James F. Dossey, Ocala, FL (US); Lyle W. Finn, Port St. Lucie, FL (US); David G. Ujhelji, Ocala, FL (US); Steven J. Magrino, Ocala, FL (US); Gerald L. Martin, Ocala, FL (US); Larry J. Scarborough, Radcliff, KY (US); Brandt Emerson, Yankeetown, FL (US); Mark Skelly, Ocala, FL (US)

Correspondence Address: SALIWANCHIK LLOYD & SALIWANCHIK, A PROFESSIONAL ASSOCIATION, 2421 N.W. 41ST STREET, SUITE A-1, GAINESVILLE, FL, 326066669

(21) Appl. No.: 09/727,067

(22) Filed: Nov. 30, 2000

Related U.S. Application Data
(60) Provisional application No. 60/168,097, filed on Nov. 30, 1999.
(60) Provisional application No. 60/250,320, filed on Nov. 30, 2000.

(51) Int. Cl. G05D 11/00; F16K 31/12; G01F 1/44; G06F 19/00

(52) U.S. Cl. 700/284; 700/9; 700/282; 239/67; 239/68; 239/69; 137/488; 137/2; 73/861.63; 705/412; 702/45; 700/60

(57) ABSTRACT

The present invention relates to an adaptable controller for controlling environmental systems, and more particularly to an improved computer-controlled irrigation and lighting system. Scheduling is selected using a unique graphical user interface and is transmitted to the controller remotely. Sensing devices for water flow to determine leaks and calculate usage using venturi are provided which communicate with the controller to adjust output in real time based on the measurements.

### CROSS-REFERENCE TO A RELATED APPLICATION

This application claims the benefit of U.S. Provisional Application No. 60/168,097, filed Nov. 30, 1999, and U.S. Provisional Application (Ser. No. not yet assigned), entitled “Computer Controlled Water Management System” filed Nov. 30, 2000 under attorney docket number VCI-100P2 having the following inventors: James F. Dossey, Lyle W. Finn, David G. Ujhelji, Steven J. Magrino, Gerald L. Martin, Larry J. Scarborough, each of which is incorporated herein by reference.

### FIELD OF THE INVENTION

The present invention relates to an adaptable controller for controlling environmental systems, and more particularly to an improved computer-controlled irrigation and lighting system.

### BACKGROUND OF THE INVENTION

Automatic irrigation sprinkler systems have been devised to supplement, or substitute for, natural rainfall in maintaining grasses, flowers, shrubbery, lawns, golf courses, parks, cemeteries, and the like. In the past, automatic irrigation sprinkler controllers were comprised of electromechanical devices which cycled water to various watering zones within the system using electrically driven program wheels having pins and cams which engaged mechanical switches to energize solenoid driven zone control valves. Such electro-mechanical controllers were generally effective and reliable, but mechanically complex and, thus, expensive to manufacture and maintain.

Over time, the electromechanical controllers of the automatic sprinkler systems have been replaced by more modern programmable analog and digital controllers. Such programmable controllers retain a desired sequence of irrigation operating instructions entered by a user. The programmable controller unit is connected to one or more solenoid valves. Each solenoid valve controls the supply of water to an area or zone. The controller unit opens and closes the solenoid valves pursuant to the entered instructions, ensuring that various zones are irrigated in the desired sequence and timing.

Typically, the modem controller uses a timing circuit that triggers the operation of the solenoid valves. Once a valve has been opened, water flows to the desired sprinkler zone until the timer sends out another signal to the valve to close, thereby shutting off the water to the zone. While the valve is open, the water flow to the zone is not monitored. In many instances, sprinkler heads can be damaged or destroyed, prohibiting water flow or allowing excessive water flow. Without a means for monitoring the water flow to a zone this damage to the sprinkler heads can go undetected resulting in an inadequate watering of the zones or waste of water. Accordingly, there is a need in the art for a device that allows performance monitoring of these irrigation systems to address the above-noted problems.

A number of irrigation control systems exist, including those described in U.S. Pat. No. 4,209,131 (Barash et al.), U.S. Pat. No. 5,748,466 (McGivern et al.), U.S. Pat. No. 5,602,728 (Madden et al.), U.S. Pat. No. 4,244,022 (Kendall), U.S. Pat. No. 5,479,338 (Ericksen et al.), U.S. Pat. No. 5,331,619 (Barnum et al.), U.S. Pat. No. 5,267,587 (Brown), U.S. Pat. No. 4,190,884 (Medina), U.S. Pat. No. 5,884,224 (McNabb et al.), and U.S. Pat. No. 4,856,344 (Hunt), each of which is incorporated herein by reference. However, the current methods of programming modem controllers can be difficult and time consuming. A majority of systems requires manually setting switches, buttons or keypads to program a zone run time. This is time consuming, especially when trying to program a number of zones. Once a zone is programmed, it is often difficult for the average user to change a sequence or run time. Accordingly, there is also a need in the art for a device that provides method and user-friendly interface.

### BRIEF SUMMARY OF THE INVENTION

The present invention solves the problems in the art by providing a novel irrigation management and control system and method, including external control mechanisms and associated computer hardware and software devices. As such, the invention can be implemented in numerous ways, including as a system, a device, a method, or a computer readable medium. Several embodiments of the invention are discussed below. As a computer system, an embodiment of the invention includes a communication device for sending and receiving data from the external control mechanisms of the irrigation system, a display device and a processor unit. The display device has a plurality of display areas (windows). The processor unit operates to send and receive data under the control of a user having access to a user friendly graphical user interface. The graphical user interface (GUI) may include a number of display areas (“windows”) for managing and controlling the irrigation system. A variety of formats for searching, scheduling, and displaying data is provided. The method of the invention can be embodied on a computer readable media containing program instructions for management and control of the irrigation system.

Irrigation systems generally comprise a water source, a water distribution system, and some sort of control device. The irrigation control system of the present invention generally comprises four main subsystems: a water source, a pressure/flow sensing device (e.g., a venturi tube) interposed between the water source and a water distribution network, a controller (e.g., Microcontroller), and a programming device (e.g., a computer system comprised of a personal computer with a modem).

In operation, the water source is connected to an inlet flange of the venturi tube with piping. The outlet flange of the venturi tube is connected to a length of piping, forming the main water line. The main water line branches into a number of secondary water sources, each corresponding to a separate watering zone with each watering zone comprising a field of sprinkler heads. The field of sprinkler heads can comprise, for example, solid-set sprinkler heads, pivoting sprinkler heads or a combination thereof. Each of the plastic or metal piping secondary water sources contains a solenoid control valve which controls the flow of water to the individual watering zones through piping.

The venturi tube is used to uniquely measure the water pressure and flow of water into the water management control system. The venturi tube consists of a hollow body with a constricted throat with two sections: an inlet converging section and an outlet diverging section.

In operation, water is present in the venturi tube. The water begins flowing through the venturi tube when the Microcontroller sends a signal to a control valve, which opens allowing water to flow into the individual zone. Typically, only one control valve will be open at any one time. The water flows through the inlet chamber through the constricted throat and out the outlet chamber. The venturi tube measures the volume of water flowing through it by sensing the differential pressure of the water flowing up through the inlet and center shafts and into a pair of electronic transducers. This differential pressure change is caused by the change in the diameter of the inlet converging section. As the water flows through the inlet converging section, the decreasing size forces the water to increase in speed and decrease in pressure. The water then flows through the constricted throat of the venturi tube at a faster rate and a lower pressure. The center electronic transducer senses the change in pressure.

The outlet flange of the venturi tube is connected to a water distribution system (e.g. sprinkler system), where the water distribution system comprises a series of solenoid control valves, which control the flow of water to each individual zone. When the Microcontroller activates the control valve, water flows through the control valve through the connecting pipe, to a network of pipes and sprinkler heads, that comprise an individual zone. The water distribution system contain at least fifteen zones, but can be programmed to contain an unlimited number of zones.

Preferably, the Microcontroller controls the system operations, being designed around the 16C74A Programmable Interrupt Controller (PIC) manufactured by MicroChip Corporation, but any controller chip such as those available from Motorola or Zenith could be used. The chip is mounted in a 40-pin low profile integrated circuit socket on a controller printed circuit board (PCB). The printed circuit board is preferably a single layer, double sided board. Other major components such as resistors and capacitors are also mounted on the board as necessary. The printed circuit board is mounted on four insulated standoff mountings at the bottom of the controller case. The controller case is standard. Holes are drilled into the case to mount the connectors.

In a preferred embodiment, the Microcontroller interfaces with all devices on the system through software control programs installed on a host computer. Once the software programs are installed, they may be automatically placed on the start menu of the Windows operating system. The Microcontroller can be accessed by a Personal Computer (PC) workstation, using Windows 9X, Windows 200x or Windows NT operating systems. The PC can access the Microcontroller through a wired connection, wireless connection, modem or like communication means. The Control Panel screen may be designed using industry standard Microsoft Windows Operating System format with a company logo, title and software version number. The Control Panel provides access to special functions such as uploading/downloading schedules, setting up the screen, designing sprinkler irrigation schedules or accessing help. The Control Panel also provides the capability to operate the sprinkler irrigation zones manually and observe performance parameters. The PC can also be programmed to control other devices in a similar manner, especially those with scheduling concerns such as exterior and interior lighting.

Accordingly, it is an object of the present invention to provide an irrigation management and control system utilizing a unique pressure/flow sensor in combination with a user programmable controller to effectuate a system that allows easy scheduling, detection of leaks, real-time reporting.

It is a further object of the invention to provide, in a water distribution network haing a water source and at least one watering zone, a programmable water management distribution system with the following components: a) a meter device for measuring water flow interposed between the water source and the water distribution network; b) at least one valve downstream from the meter device which operates to provide water to the water distribution network; and c) a programable controller connected to the valve, the controller operating to open and close the valve in accordance with a predetermined schedule and wherein the controller is responsive to flow measurements of the meter device. Preferably, the meter includes a venturi tube having an inlet section and a constricted throat. The meter device has at least one transducer, wherein the transducer is removably affixed to the venturi tube and in physical communication with the water traveling through the venturi tube, the transducer being connected to the controller. A first transducer is positioned within the constricted throat and a second transducer is positioned within the inlet chamber. A leak detection device which operates to close the valve when the flow measurements of the meter device exceed a preset limit is also provided as an advantage of the present invention. A feature of the invention is that the controller is remotely programmable. As such, the water flow to the zones from the flow measurements of the meter device can be continually monitored. A water usage report may be generated.

The programmable water management distribution system can also turn on and off the electrical devices in accordance with a preprogrammed schedule and may include an electrical metering device, such that the electrical metering device measures electricity usage. It may also include a rain sensor connected to the programmable controller, such that when activated the rain sensor disables the at least one valve when rain is detected.

The programmable controller for controlling activation of an irrigation system includes a memory device for storing scheduling information for the irrigation system, the scheduling information provided by remote programming device; electrical circuitry for interfacing with and activating at least one irrigation valve for controlling water flow therethrough; processor unit for signaling the electrical circuitry to activate the irrigation valve based upon the scheduling information; and sensor device for detecting flow measurements of the irrigation system and providing the flow measurements to the processor unit to allow adjustments to or overriding of the scheduling information based on the measurements.

It is another object of the present inveinton to provide a method of controlling a water management distribution system comprising a programmable remote system connected to a controller of a water distribution network, having the following steps: a) receiving a watering schedule in the remote system; b) transmitting the watering schedule to the controller; c) controlling the distribution system in accordance with the schedule; and d) real-time adjusting of the watering schedule by the controller based on external inputs to the controller. The method also may include a) storing a daily water usage; b) calculating an average water usage from the daily water usage; c) calculating an adjusted water flow rate; and d) adjusting water flow rate in accordance with the calculations. Moreover, the method may also include a) storing at least one flow rate preset limit; b) comparing the adjusted flow rating to the flow rate preset limit; and c) shutting down a zone when the adjusted flow rate is outside the flow rate limit.

A further object of the present invention is to provide an automatic shut-off system for a water supply line having a) a valve for opening and closing the water line; b) control device for controlling the valve; c) a venturi tube disposed within the water line having sensors for sensing a pressure change in the water line cause by flow in the water line; d) device for sending a signal from the sensors to the control device indicative of flow; e) device for comparing the signal with a preset limit; f) device for selectively closing the valve should the signal exceed the preset limit.

It should be understood that the examples and embodiments described herein are for illustrative purposes only and that various modifications or changes in light thereof will be suggested to persons skilled in the art and are to be included within the spirit and preview of this application.

Other aspects and advantages of the invention will become apparent from the following detailed description taken in conjunction with the accompanying drawings, illustrating by way of example the principles of the invention.

All patents, patent applications, provisional applications, and publications referred to or cited herein, or from which a claim for benefit of priority has been made, are incorporated herein by reference in their entirety to the extent they are not inconsistent with the explicit teachings of this specification.

### BRIEF DESCRIPTION OF THE DRAWINGS

FIG. 1 is a schematic drawing of the preferred embodiment of the Water Management Control system of the present invention.

FIG. 2A is a top view of the venturi tube of the present invention.

FIG. 2B is a cross section view of the venturi tube of FIG. 2A.

FIG. 2C is a view of the flow sensor in the venturi tube.

FIG. 2D shows the differential pressure transducer.

FIG. 3A is an isometric view of the Microcontroller box of the preferred embodiment with a Light Emitting Diode (LED) panel.

FIG. 3B is a top view of the Microcontroller box with LED panel and barrier strip of the preferred embodiment.

FIG. 3C is a left side and lower end view of the Microcontroller box of the preferred embodiment.

FIG. 3D is a top view of the Microcontroller box with a Liquid Crystal Display (LCD) and barrier strip of an alternate embodiment.

FIG. 3E is an isometric view of the Microcontroller box of an alternate embodiment with a Liquid Crystal Display (LCD) panel.

FIG. 4A is a top view of the Microcontroller printed circuit board (PCB) of the preferred embodiment.

FIG. 4B is a schematic drawing of the Microcontroller electronic circuitry of the preferred embodiment.

FIG. 4C is a schematic drawing of the sensor card of the preferred embodiment.

FIG. 4D is a schematic of the Microcontroller LED card assembly of the preferred embodiment.

FIG. 5 is an isometric view of the enclosure case of the preferred embodiment.

FIG. 6A is a schematic drawing showing the Control Panel computer screen window of the preferred embodiment.

FIG. 6B is a schematic drawing of the Modify Zone Name computer screen window of the preferred embodiment.

FIG. 6C is a schematic drawing of the Zone Chart computer screen window of the preferred embodiment.

FIG. 6D is a schematic drawing of the Graphical Scheduler Help (page 1) computer screen window of the preferred embodiment.

FIG. 6E is a schematic drawing of the Graphical Scheduler Help (page 2) computer screen window of the preferred embodiment.

FIG. 6F is a schematic drawing of the Graphical Scheduler Help (page 3) computer screen window of the preferred embodiment.

FIG. 6G is a schematic drawing of the Advanced Controls Login computer screen window of the preferred embodiment.

FIG. 6H is a schematic drawing of the Cycle Zones computer screen window of the preferred embodiment.

FIG. 6I is a schematic drawing of the Advanced Details computer screen window of the preferred embodiment.

FIG. 7A is a schematic drawing of the Setup computer screen window of the preferred embodiment.

FIG. 7B is a schematic drawing of the Modify Phone Number/Password computer screen window of the preferred embodiment.

FIG. 7C is a schematic drawing of the Setup computer screen window of the preferred embodiment with Modem/RS232 drop down window.

FIG. 7D is a schematic drawing of the Setup Auto Detect Modem computer screen window of the preferred embodiment.

FIG. 7E is a schematic drawing of the Setup Modem Found computer screen window of the preferred embodiment.

FIG. 8A is a schematic drawing of the Schedule Designer computer screen window of the preferred embodiment.

FIG. 8B is a partial schematic drawing of the Schedule Designer Scheduler Matrix computer screen window of the preferred embodiment.

FIG. 8C is a partial schematic drawing of the Schedule Designer Scheduler Matrix computer screen window of the preferred embodiment with the Select Zone drop down menu.

FIG. 8D is a partial schematic drawing of the Schedule Designer Scheduler Matrix computer screen window of the preferred embodiment with the Run Time drop down menu.

FIG. 8E is a schematic drawing of the File Open computer screen window of the preferred embodiment.

FIG. 8F is a schematic drawing of the File Save As computer screen window of the preferred embodiment.

FIG. 9A is an electronic schematic diagram of the Master Control assembly of the Microcontroller.

FIG. 9B is an electronic schematic diagram of the Modem Card assembly of the Microcontroller.

FIG. 9C is an electronic schematic diagram of the Tone Ringer Card assembly of the Microcontroller.

FIG. 9D is an electronic schematic diagram of the Cable and Box Interface assembly of the Microcontroller.

FIG. 10 is a conceptual diagram cross sectional view of a typical venturi tube.

FIGS. 11A through 11Z is the flowchart of the operation of the sprinkler control software of the present invention.

### DETAILED DISCLOSURE OF THE INVENTION

It will be readily understood that the components of the present invention, as generally described and illustrated in the Figures herein, could be arranged and designed in a wide variety of different configurations. Thus the following more detailed description of the embodiments of the system and method of the present invention, as represented in the Figures, is not intended to limit the scope of the invention as claimed, but is merely representative of the presently preferred embodiment of the invention.

The presently preferred embodiments of the invention will be best understood by reference to the drawings wherein like parts are designated by like numerals throughout.

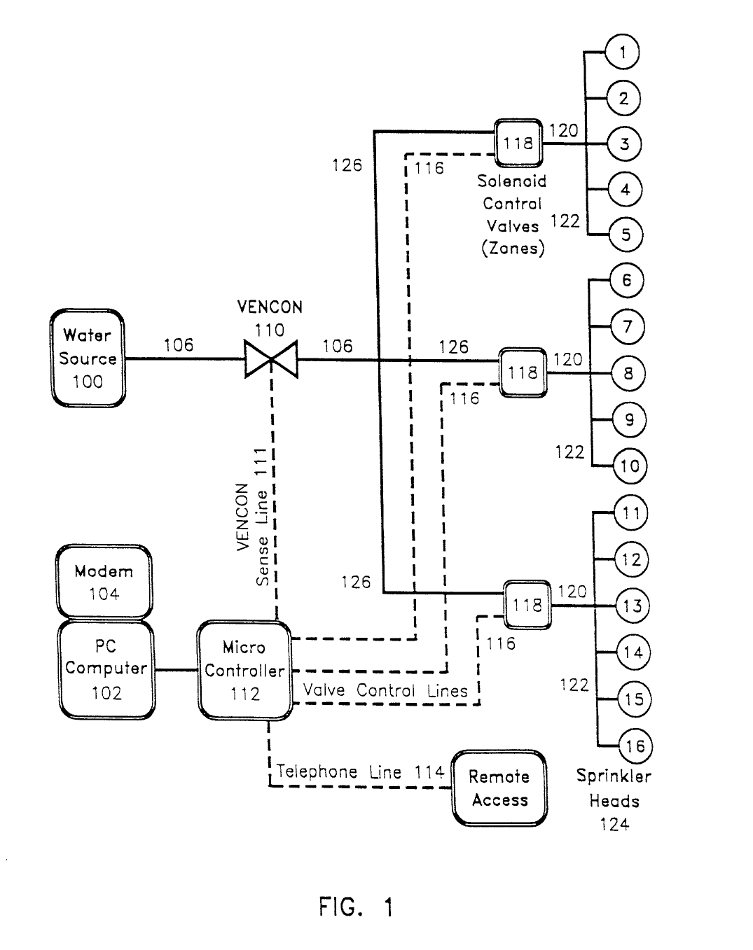

One presently preferred embodiment of the invention, designated generally at 90, is illustrated in FIG. 1. As shown, the Water Management Control System 90 of the present invention comprises four main subsystems: a water source 100, a venturi tube 110 connecting the water source 100 to a water distribution network 106, a Microcontroller 112, and a computer system comprised of a personal computer 102 with a modem 104.

The water management control system 90 is connected to the water distribution network 106, comprised of individual sprinklers 124 grouped into separate zones 122, where each zone 122 is controlled by a solenoid control valve 118.

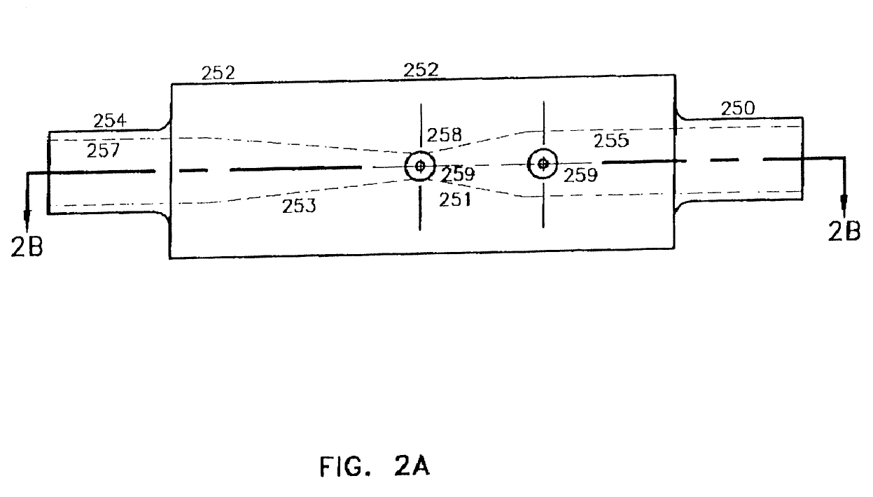

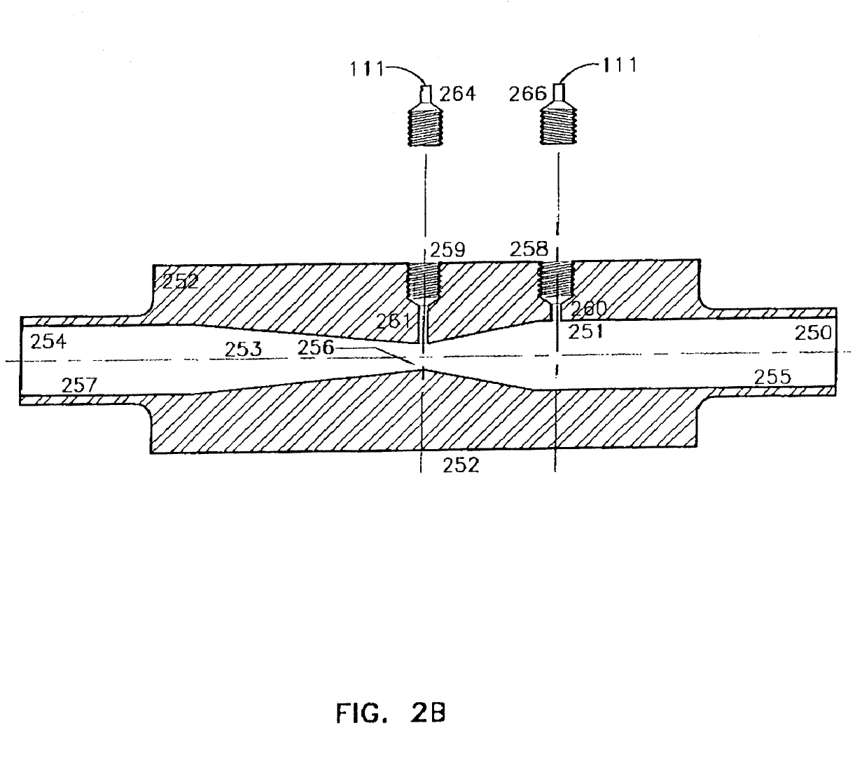

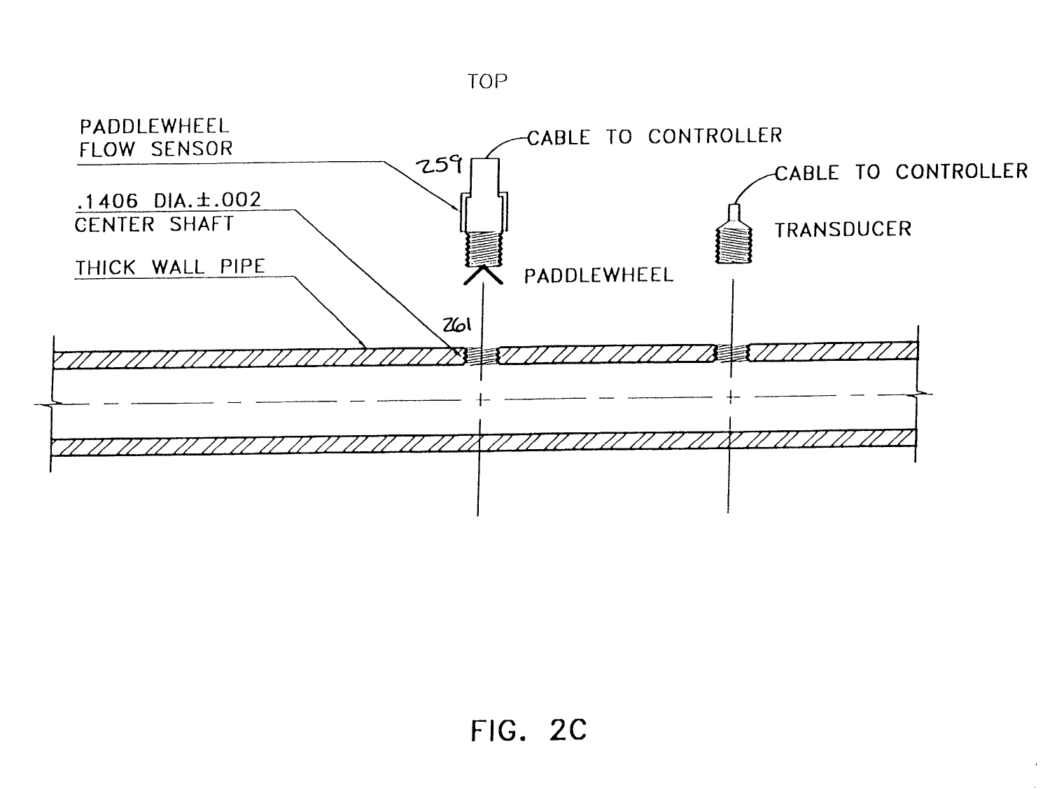

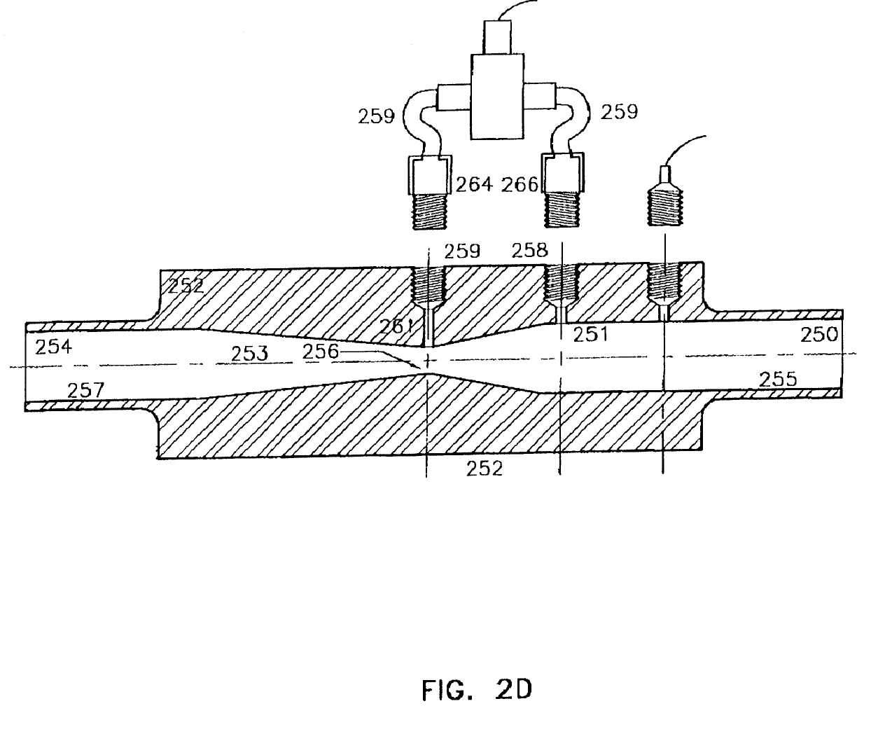

In an embodiment, as shown in FIGS. 1 and 2A, the water source 100 is connected to an inlet flange 250 of the venturi tube 110 with piping. The outlet flange 254 of the venturi tube 110 is connected to a length of piping, forming the main water line 106. The main water line 106 branches into a number of secondary water sources 126, each corresponding to a separate watering zone 122 with each watering zone 122 comprising a field of sprinkler heads 124. The field of sprinkler heads 124 can comprise, for example, solid-set sprinkler heads, pivoting sprinkler heads or a combination thereof. Each of the plastic or metal piping secondary water sources 126 contains a solenoid control valve 118 which controls the flow of water to the individual watering zones 122 through piping 120. In an embodiment, the piping 120 is standard 1-inch schedule 40 polyvinylchloride (PVC) plastic pipe.

A venturi tube is defined as one of a number of known devices for measuring the flow rate of a fluid through a pipe, providing a high range of sensor accuracy. A differential pressure measurement between two sections of a pipe of different diameters and joined by a smooth change in diameter can be interpreted using Bernoulli's equation, to provide a measure of momentum change and thus velocity. Venturi tubes are useful in pipes because they are more robust and less prone to erosion than other known devices, such as the turbine meter. In addition, they do not intrude into the pipe itself.

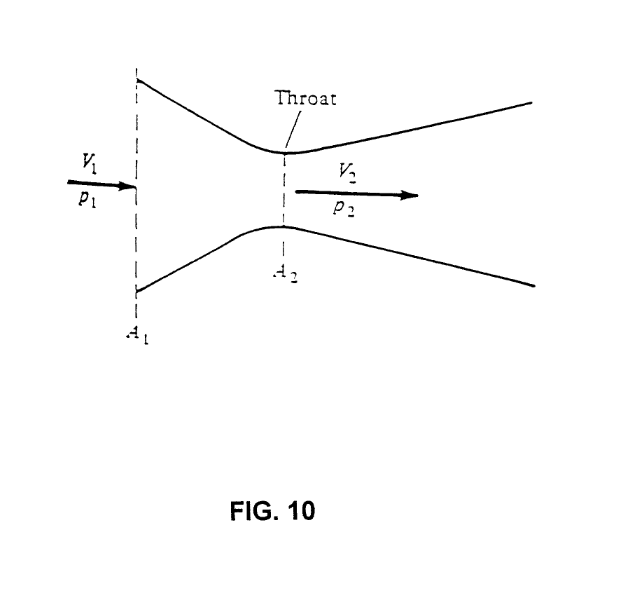

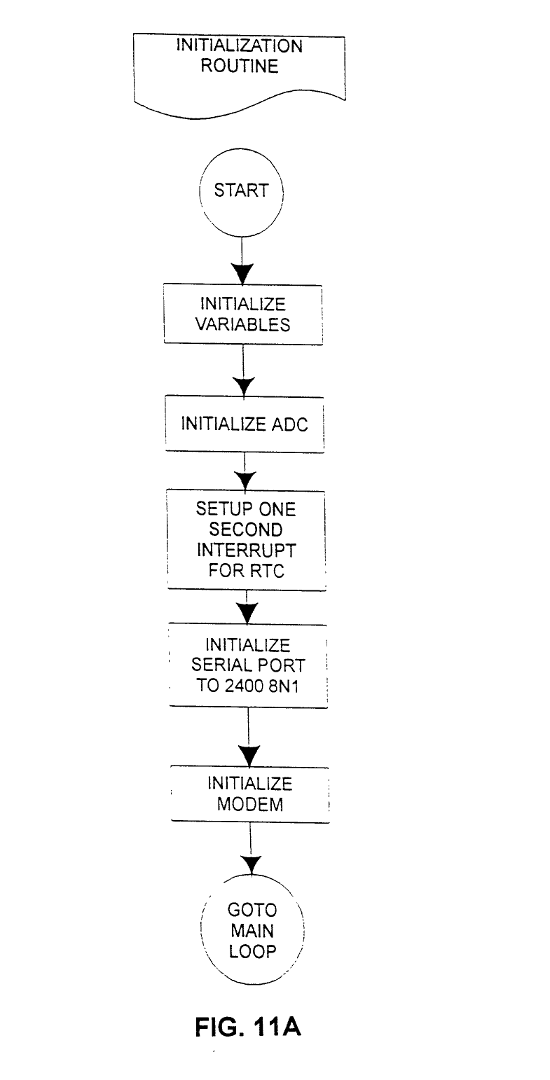

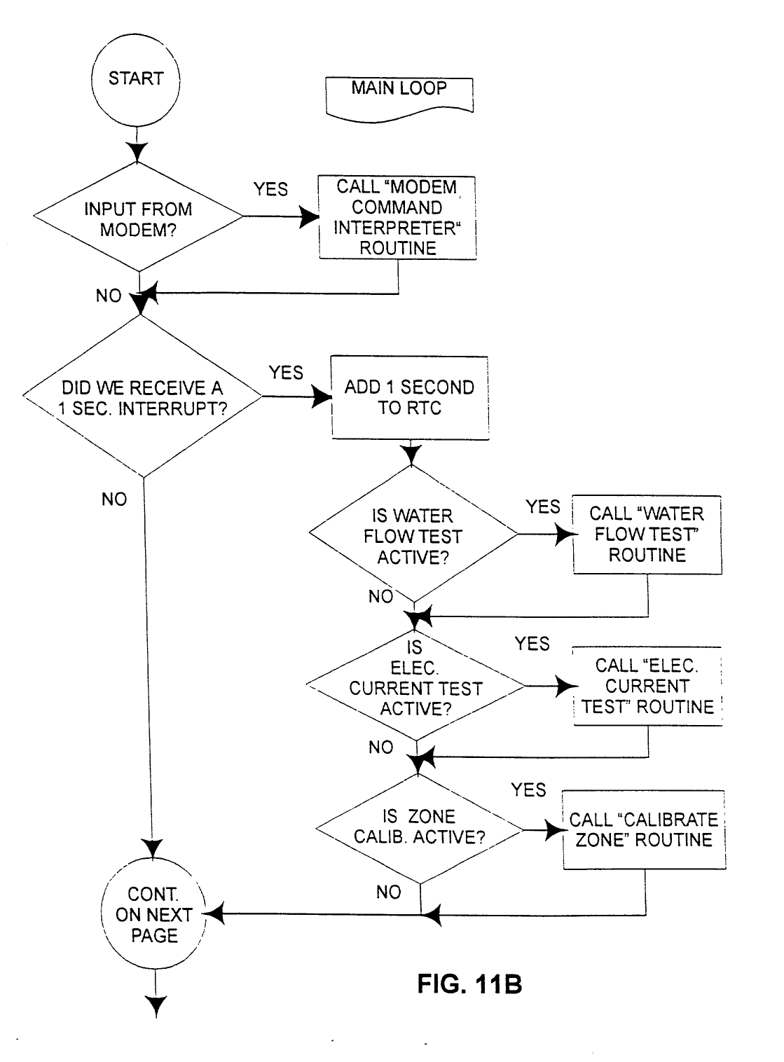

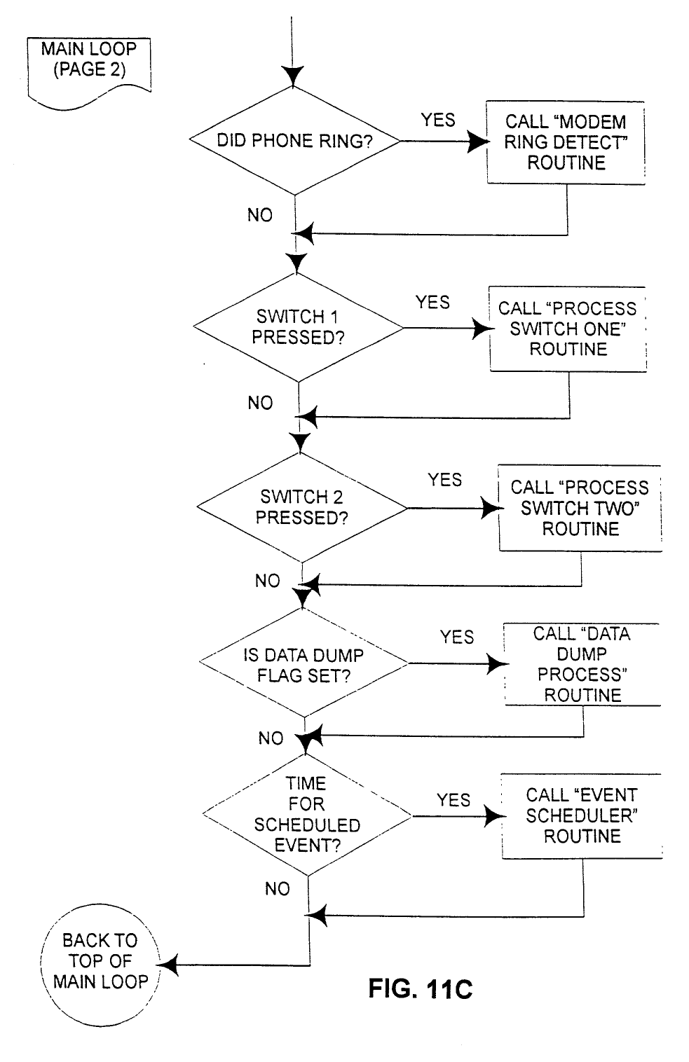

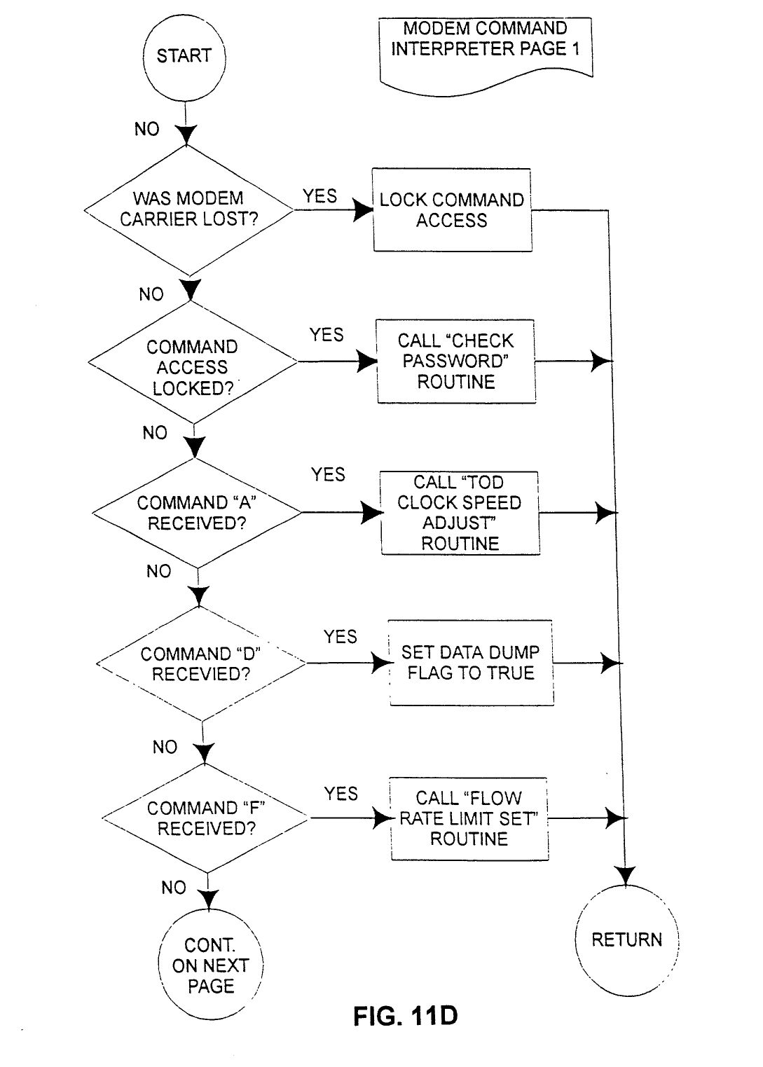

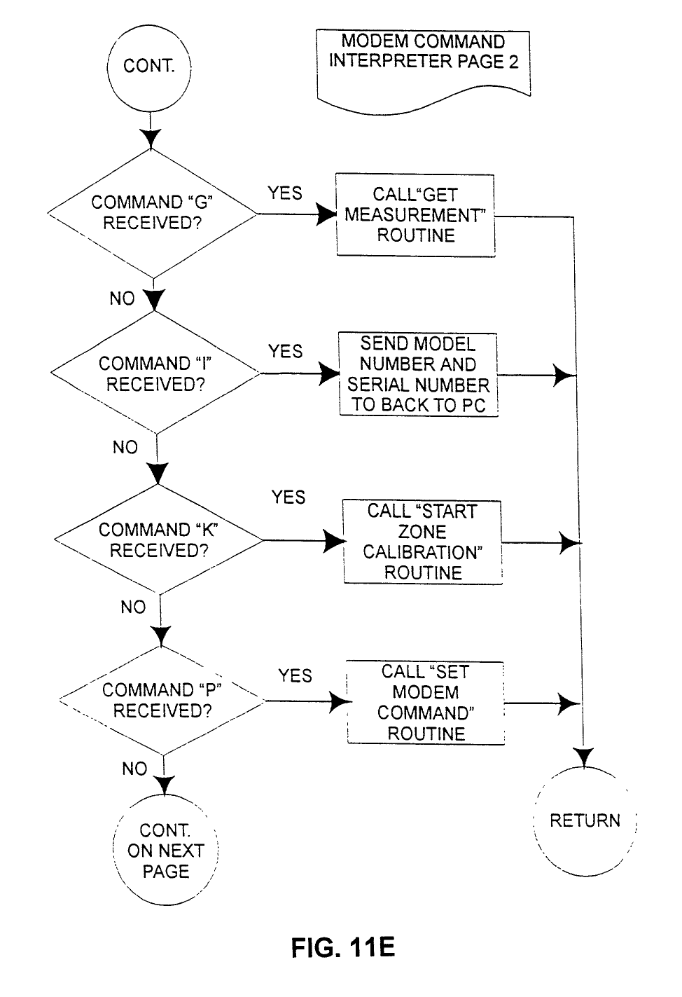

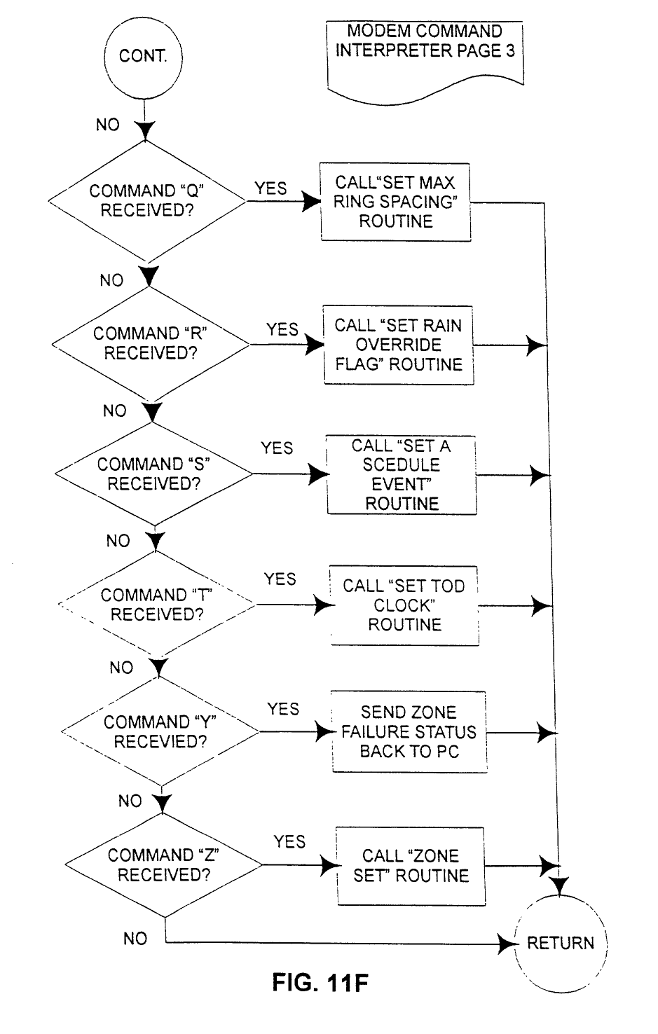

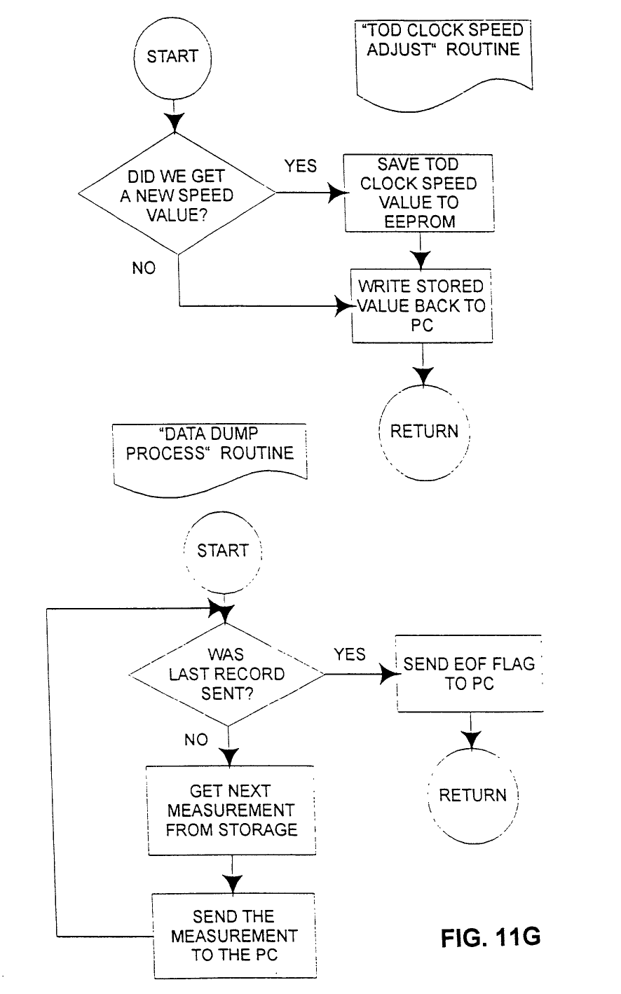

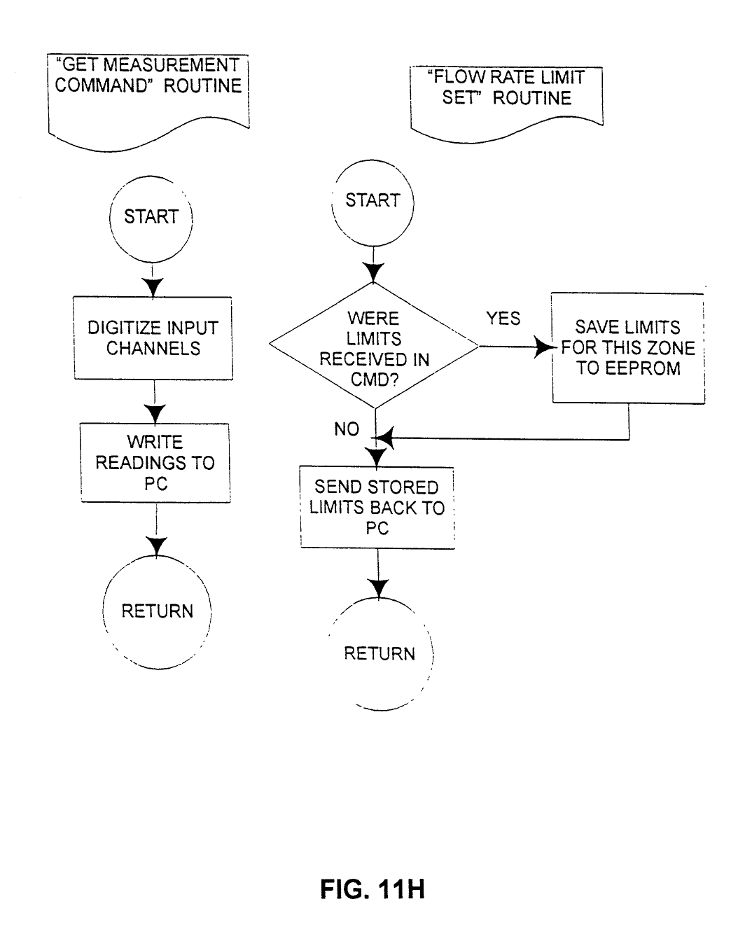

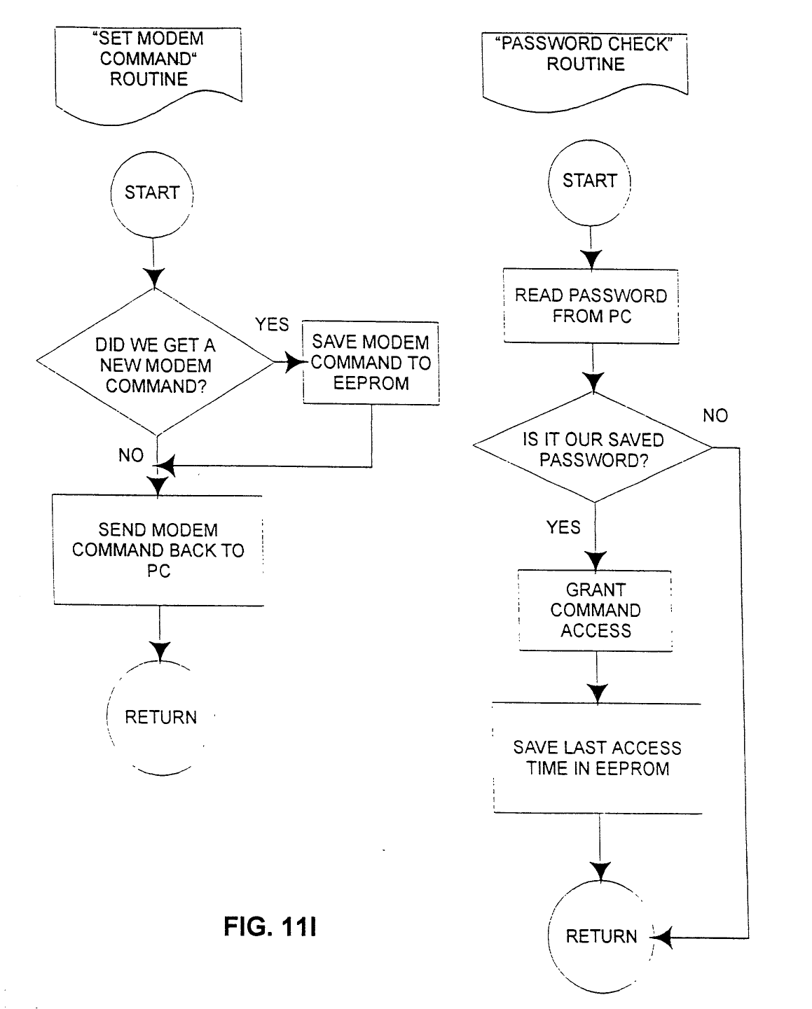

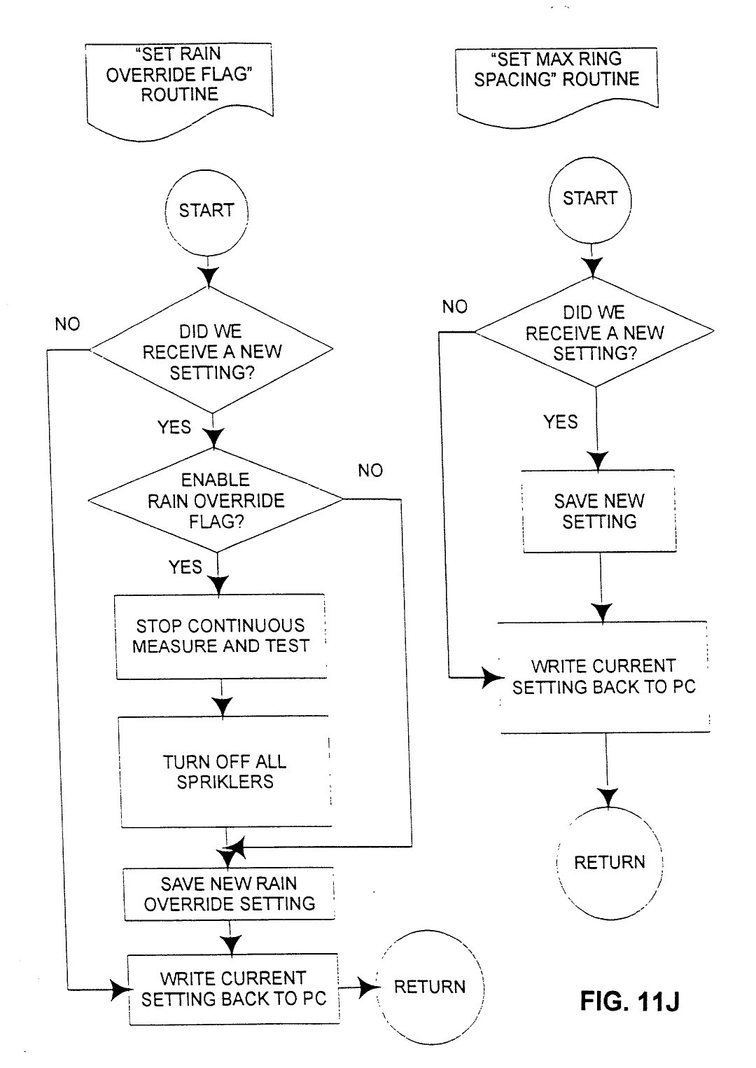

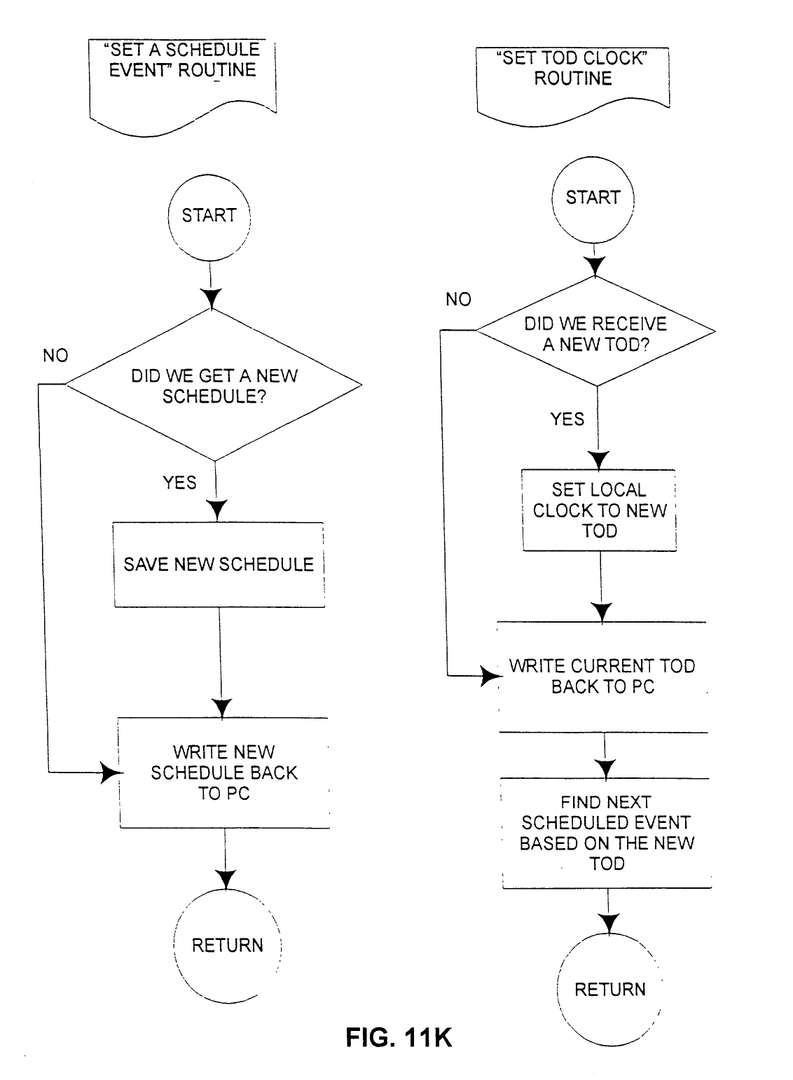

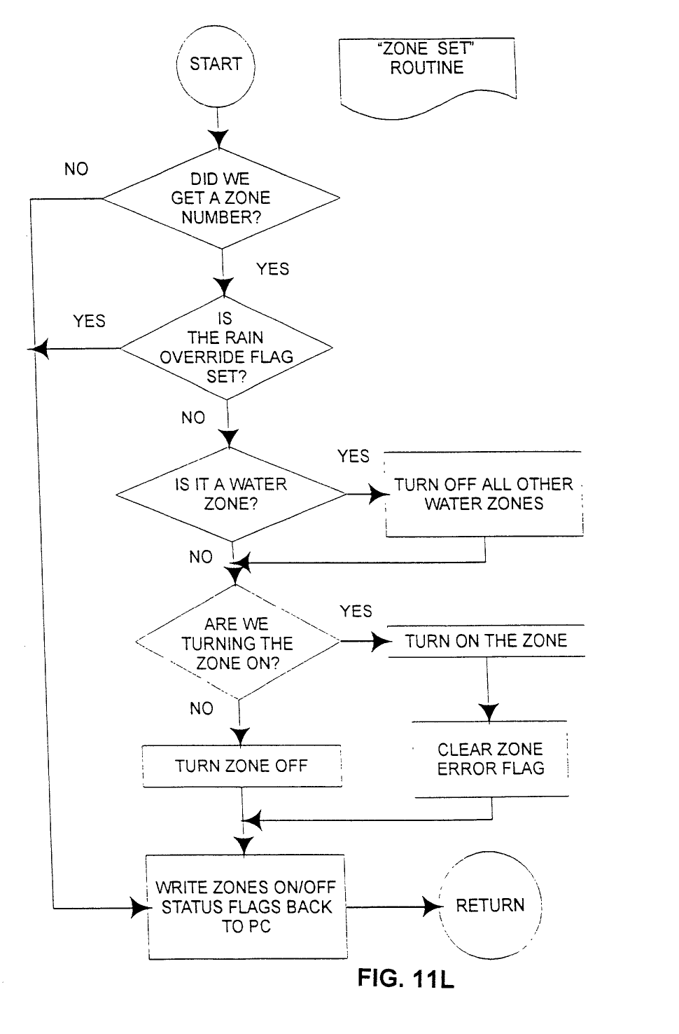

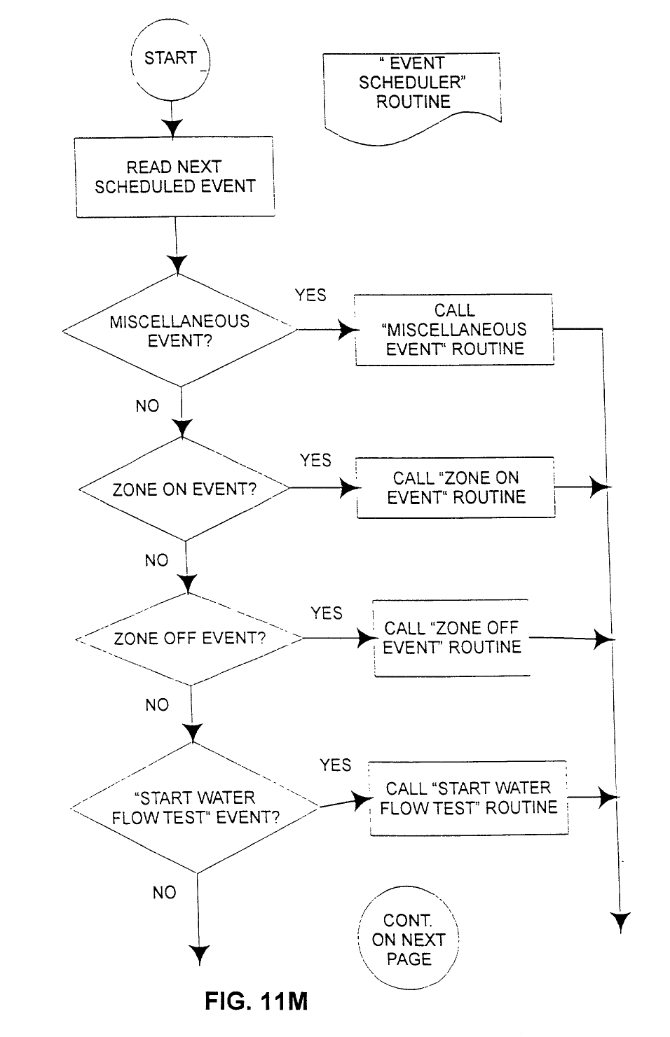

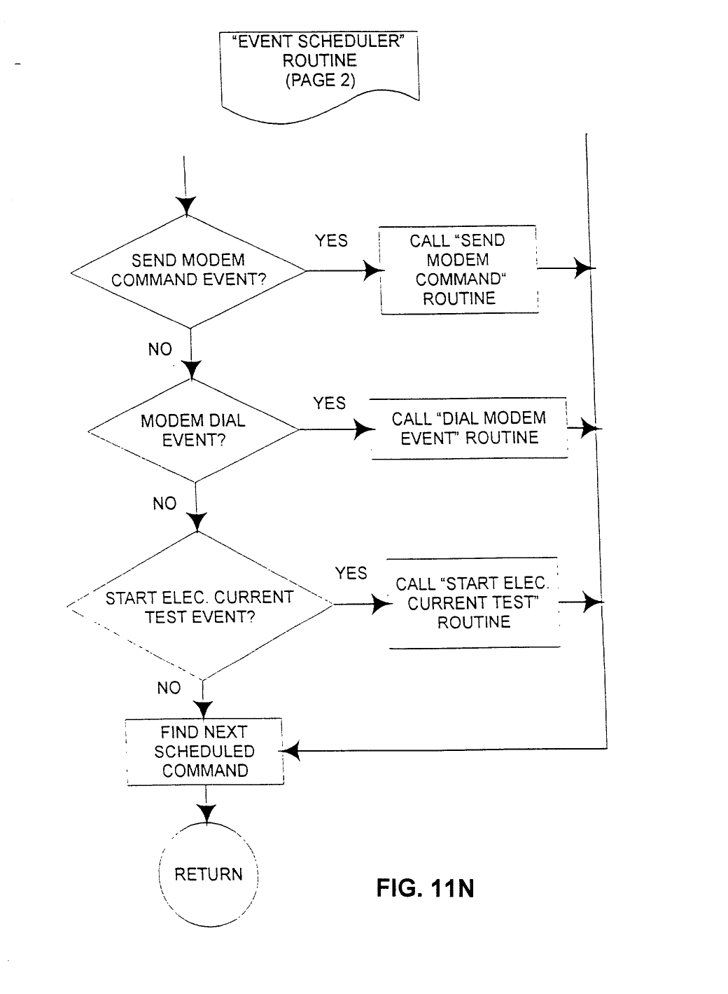

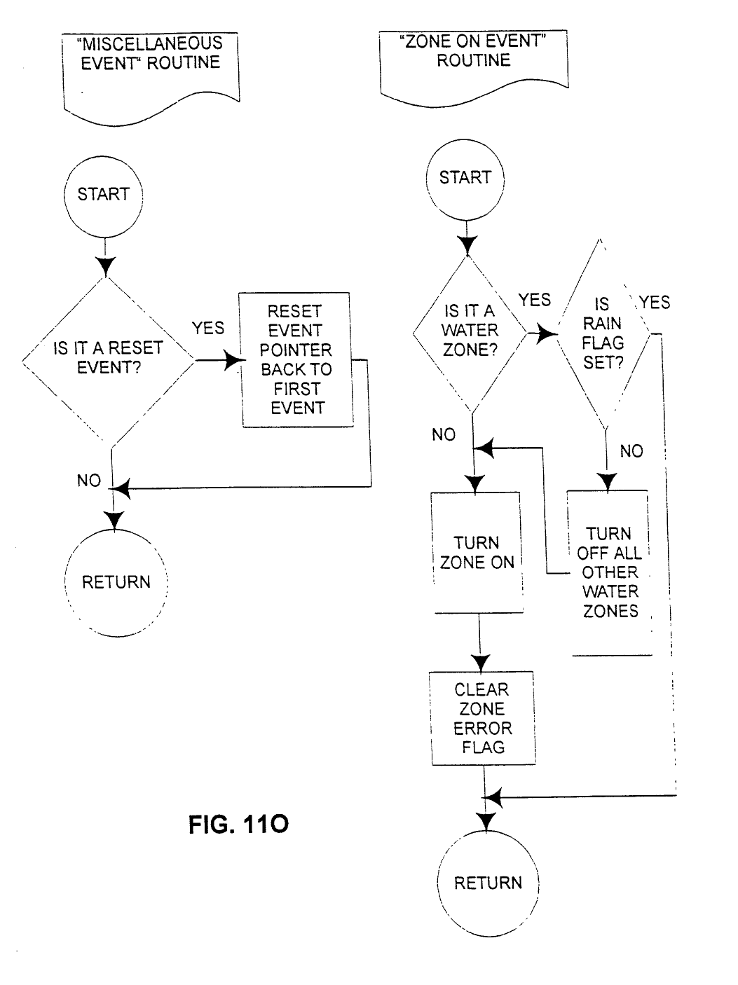

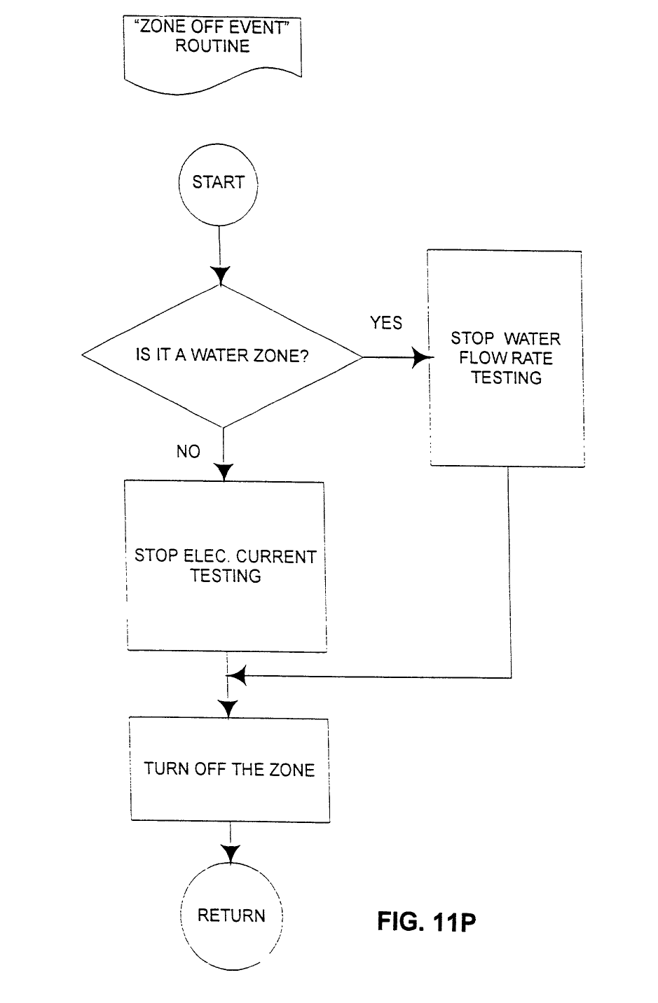

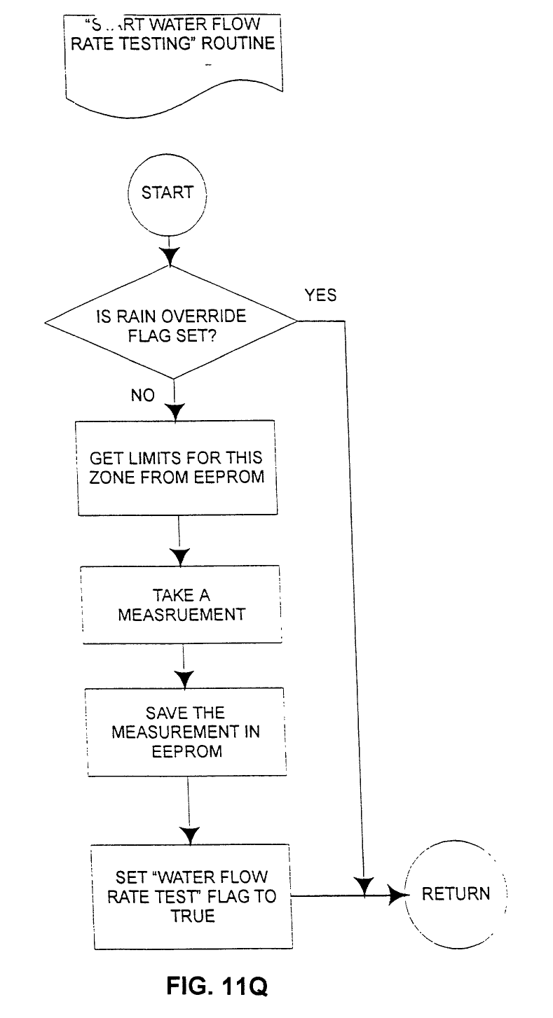

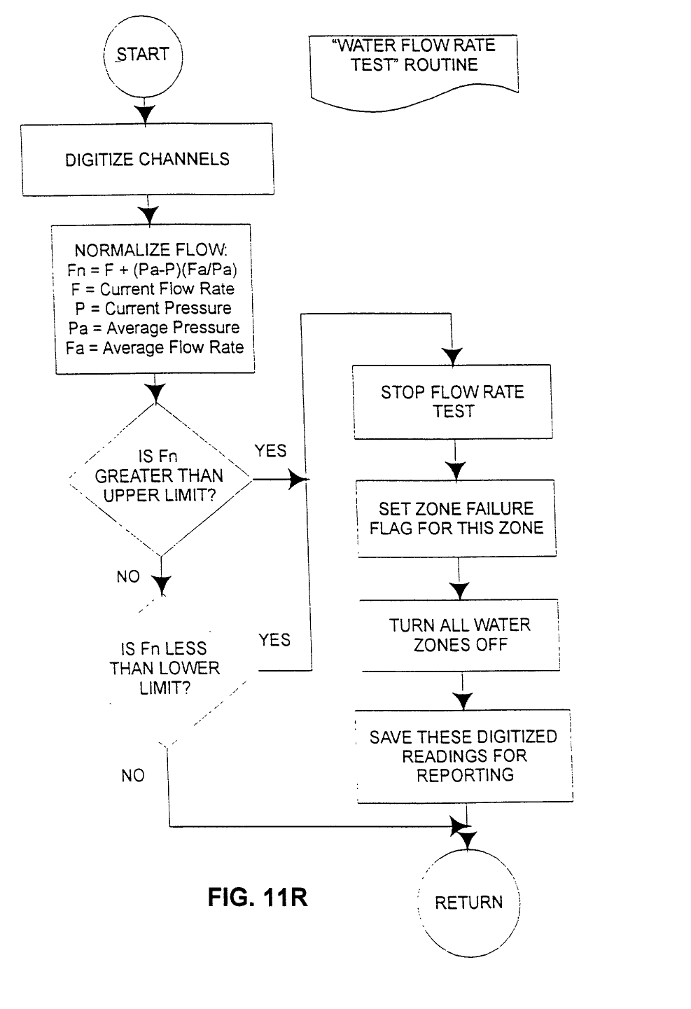

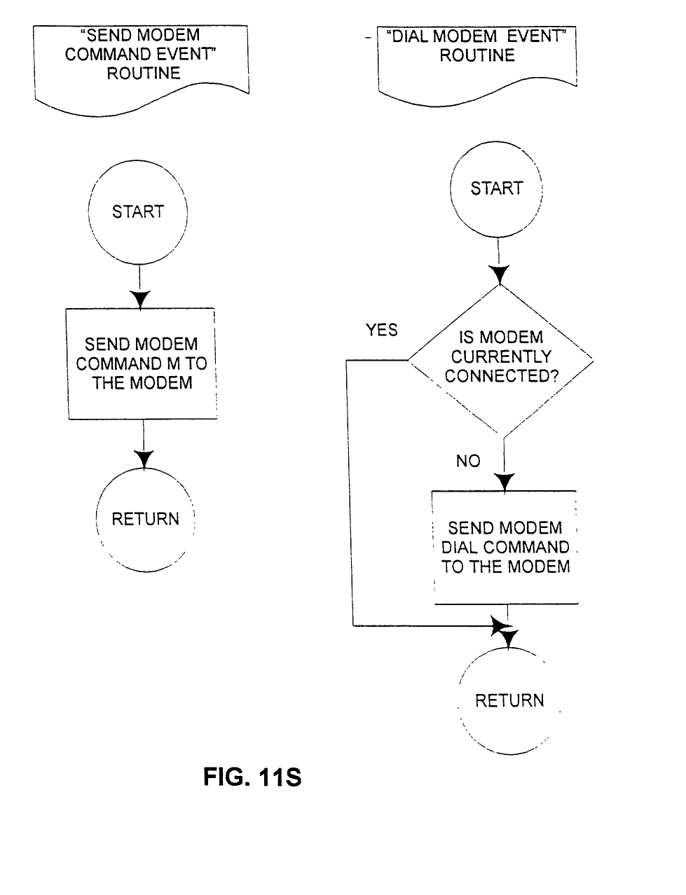

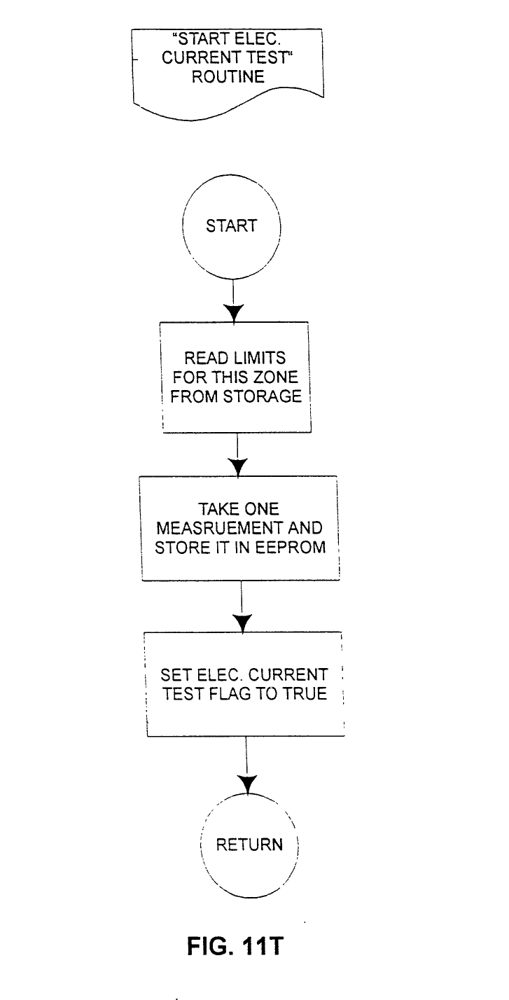

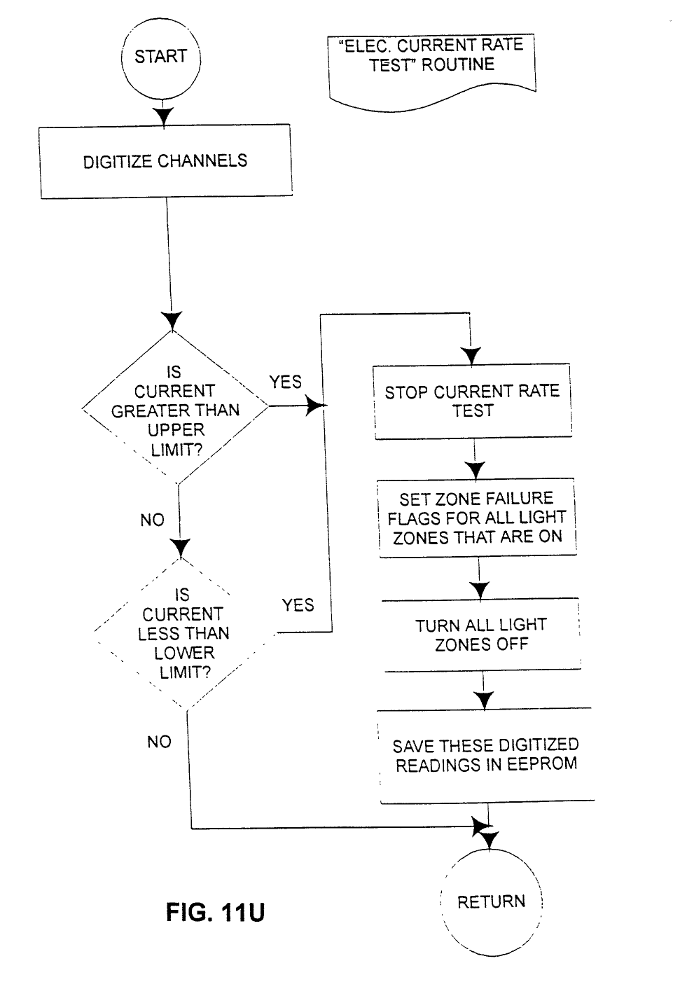

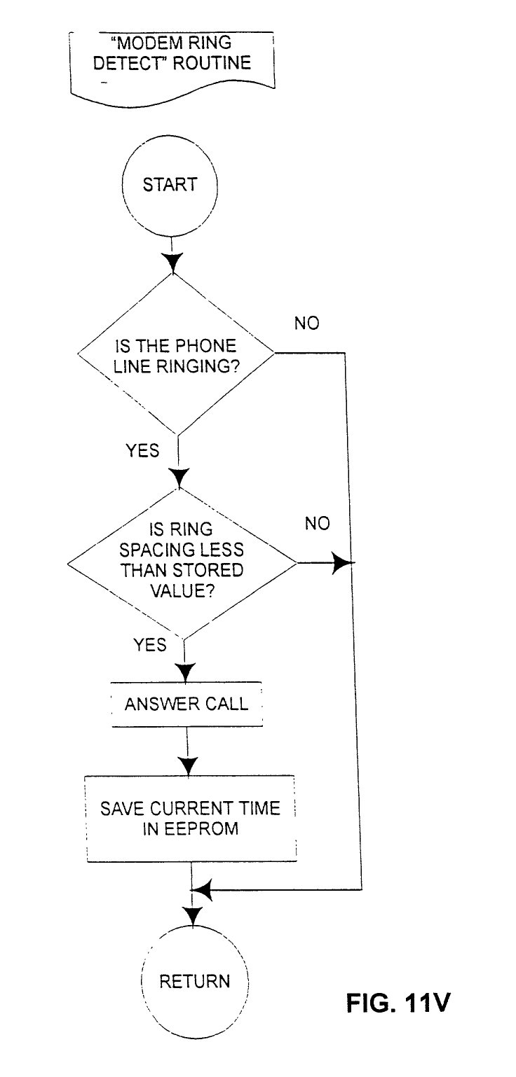

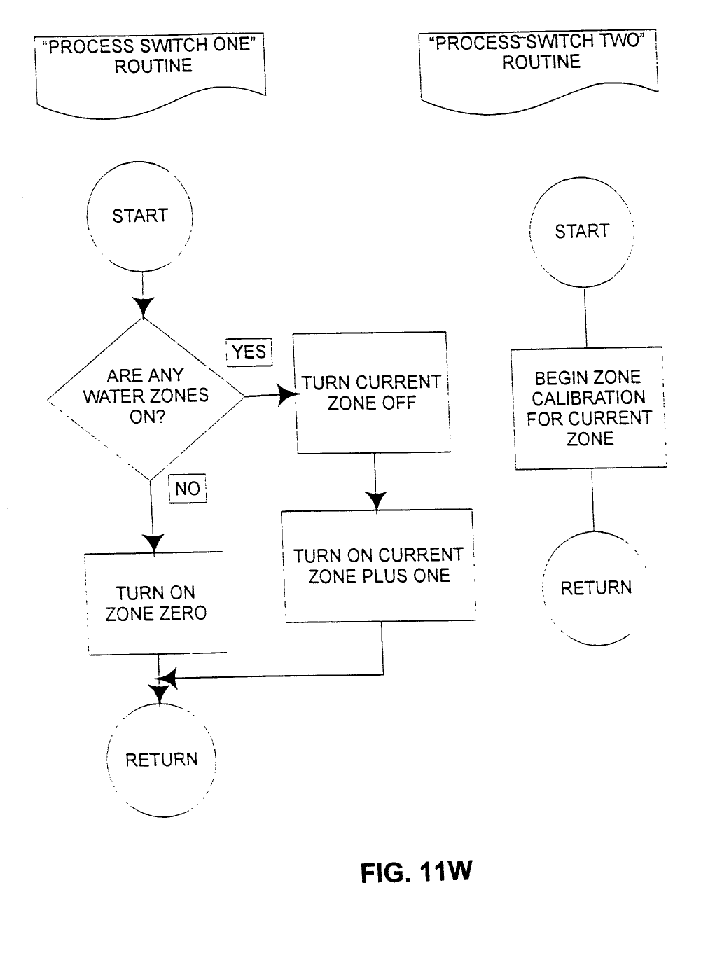

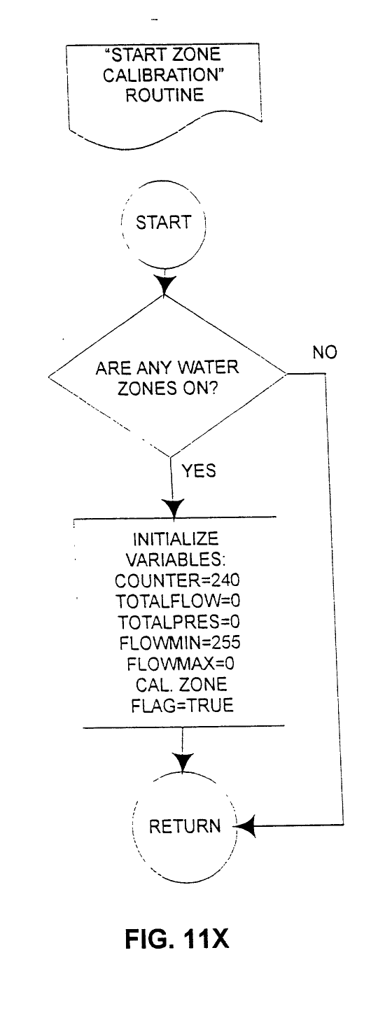

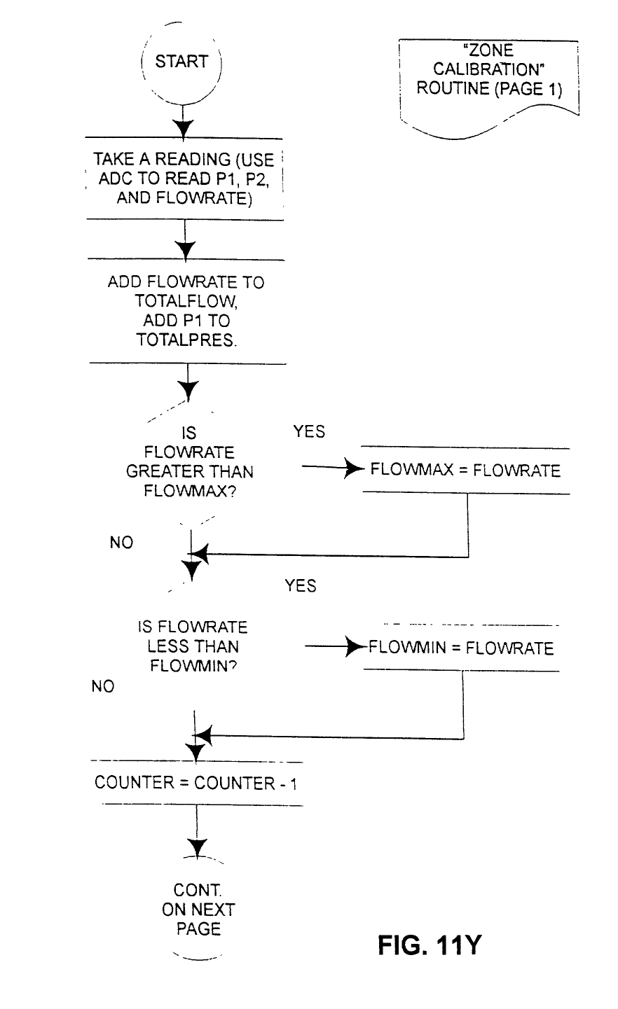

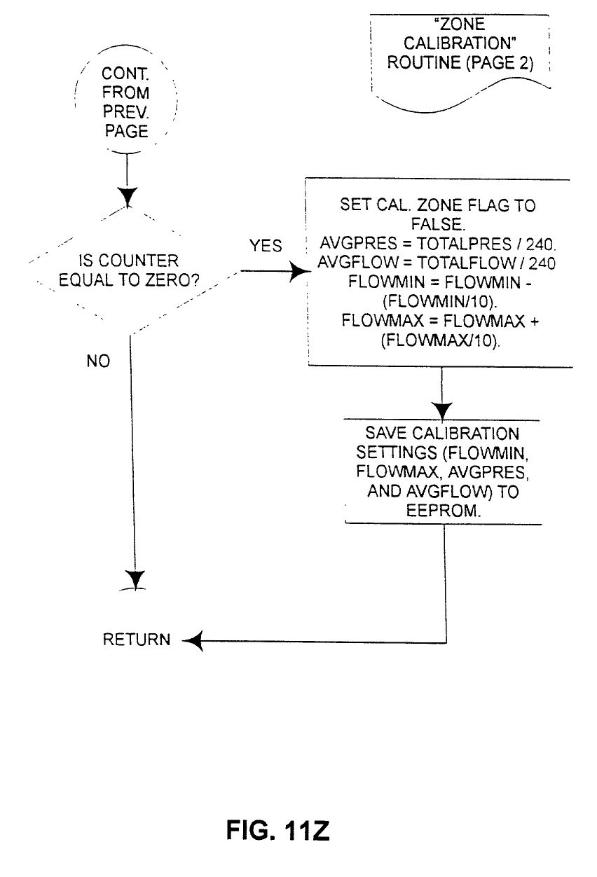

The venturi tube 10 as shown in FIGS. 2B and 10 is generally defined as atube with an inlet having area A₁, fluid velocity V₁, and pressure P₁. The inlet is followed by a convergent section, which converges to a minimum area called a throat, with an area A_{T}, fluid velocity V_{T}, and pressure P_{T} Downstream of the throat is a divergent section that diverges to the outlet, with an area A₂, fluid velocity V₂ and pressure P₂. When in use, a fluid enters the inlet with an initial fluid velocity V₁ and pressure P₁. As the fluid travels through the convergent section, the fluid velocity increases and the pressure decreases, achieving a maximum fluid velocity, V_{T} and a minimum pressure P_{T} at the throat. In the divergent section, downstream of the throat, the fluid velocity decreases and the pressure increases, reaching fluid velocity V₂ and pressure P₂ in the outlet.

In application, for an incompressible flow with a constant density r, the venturi tube can be used to measure the fluid velocity at the inlet, throat or outlet by measuring pressures P₁ and P_{T} with pressure sensors, and calculating the fluid velocity using the following equations:

V₁=(2(P₁−P_{T})/r[(A₁/A_{T})²−1])²

where

V_{T}=(A₁/A_{T})V₁

and

V₂=(A_{T}/A₂)V_{T}

Referring now to FIGS. 2A and 2B, the venturi tube 110 is used to measure the water pressure and flow of water into the water management control system 90. The venturi tube 110 consists of a hollow body 252 with a constricted throat 256 with two sections: an inlet converging section 251 and an outlet diverging section 253.

In an embodiment, the venturi tube 110 is a cylindrical tube with contiguous sections: an inlet flange 250 with an inlet converging section 251 converges to a constricted throat 256 located at the center the body 252; an outlet diverging section 253 diverges from the constricted throat 256 to an outlet flange 254 on the opposite end. The outside dimension of the inlet and outlet flanges 250 and 254 allow for connection to a standard pipefitting.

The venturi tube 110 can be manufactured from various stock materials such as PVC, plastic, aluminum, copper or steel. Other materials from which the venturi tube may be manufactured include stainless steel, galvanized steel, bronze, brass, glass, epoxy, resin, fiberglass, acrylic, or other types of plastics. In a preferred embodiment as shown in FIG. 2A, the venturi tube is constructed using schedule 40 polyvinylchloride (PVC) plastic material.

In an embodiment, as shown in FIGS. 2A and 2B, the overall length of the venturi tube is approximately 12.05 inches including both flanges. The inlet flange 250 is 2.04 inches long with an outside diameter of 1.296 inches and an inside diameter of 1.03 inches, leaving a wall thickness of 0.133 inches. The outlet flange 254 is 1.99 inches long with the same outside and inside diameter as the inlet flange. The flanges conjoin to the body with a filet radius of 0.25 inches around the circumference of the flange. The body 252 is 8.02 inches long with an outside diameter of 2.77 inches. The body 252 preferably maintains a constant cylindrical exterior diameter, but is hollowed out on the inside to form a small constricting throat 256 in the exact center of the body 252. From the inlet flange 250, the body 252 maintains the inside diameter of the inlet chamber 255 at 1.03 inches for a distance of 4.4377 inches. The inlet chamber 255 then tapers down in the inlet converging section 251 to an inside diameter of 0.4 inches in a distance of 1.5573 inches where it meets the constricted throat 256. The angle of the taper of the inlet converging section 251 is 11.1038 degrees. The constricted throat 256 is 0.15 inches wide with an inside diameter of 0.4 inches. From the edge of the constricted throat 256, the inside of the body tapers out in the outlet diverging chamber 253 at an angle of 5.4281 degrees for a distance of 3.2914 inches, increasing to an inside diameter of 1.03 inches matching the inside diameter of the outlet chamber 257. The diameter of the outlet chamber remains constant for a distance of 2.6136 inches ending at the outlet flange 254.

In a preferred embodiment, two threaded pipe taps are located in the top of the venturi tube 110, the inlet tap 258 and the center tap 259. The inlet tap 258 and the center tap 259 are for the connecting of a pair of electronic transducers 264 and 266 into the venturi tube 110. The center tap 259 is located in the centerline of the body 252 over the constricted throat 256. The location of the inlet tap 258 can vary as long as it remains within the inlet chamber 255 portion of the body 252. In an embodiment the inlet tap 258 is located 1.955 inches center to center from the center tap 259 in the direction of the inlet flange 250.

The lower section of the transducers 264 and 266 are tapered and threaded. The transducers 264 and 266 are removably affixed to the venturi tube 110 by inserting the threaded section of the transducers 264 and 266 into the inlet and center taps 258 and 259 on the body 252 of the venturi tube 110. The electronic transducers 264 and 266 are then tightened securely.

In an embodiment, the inlet tap 258 and the center tab 259 are 0.5 inches deep by 0.25-inch diameter standard pipe tap holes threaded to accept standard machine bolts. Located at the bottom center of each tap is a shaft 260 and 261 drilled through the body wall into the body cavity. In a preferred embodiment, the shafts 260 and 261 have a 0.1406+/−0.002 inches inside diameter. The inlet shaft 260 is approximately 0.685 inches long and the center shaft 261 is approximately 0.37 inches long.

In a preferred method of use, water is always present in the venturi tube 110 while in operation. The water flows through the venturi tube 110 when the Microcontroller 112 sends a signal to a solenoid control valve 118, which opens allowing water to flow into the individual zone 122. Preferably, only one control valve 118 will be open at any one time. The water flows through the inlet chamber 255 through the constricted throat 256 and out the outlet chamber 257. The venturi tube 110 measures the volume of water flowing through it by sensing the differential pressure of the water flowing up through the inlet and center shafts 260 and 261 into a pair of electronic transducers 264 and 266. This differential pressure change is caused by the change in the diameter of the inlet converging section 251. As the water flows through the inlet converging section 251, the decreasing size forces the water to increase in speed and decrease in pressure. The water then flows through the constricted throat 256 of the venturi tube 110 at a faster rate and a lower pressure. The center electronic transducer 264 senses the change in pressure.

The outlet flange 254 of the venturi tube 110 is connected to a water distribution system 106. In a preferred embodiment, the water distribution system 106 comprises a series of solenoid control valves 118, which control the flow of water to each individual zone 122. In one embodiment, the control valve 118 is a standard 24-volt electrically operated valve actuated through a control line 116 from the Microcontroller 112. When the Microcontroller 112 activates the control valve 118, water flows through the control valve 118 through the connecting pipe 120, to a network of pipes and sprinkler heads 124, that comprise an individual zone 122. In preferred embodiment, the water distribution system contains 106 up to fifteen zones, but can be programmed through the proprietary software to contain an unlimited number of zones.

The electronic transducers 264 and 266 are used to translate and send water flow data from the venturi tube 110 to the Microcontroller 112. The electronic transducers 264 266 are standard items that may be purchased from a variety of vendors. In one embodiment, the electronic transducers 264 and 266 are passive analog devices that sense the dynamic pressure and flow acceleration of the water being transported through the venturi tube into to the water distribution system. The water pressure and flow is translated into an analog signal by a sensor card. The signal is then sent to the Microcontroller 112 through a transducer cable 111 attached to the head of each transducer 264 and 266. The lengths of the transducer cables 111 vary depending on the distance between the venturi tube 110 and the Microcontroller 112. In one embodiment, a five-pin DIN connector on the end of each transducer cable is plugged into the Microcontroller 112.

In an embodiment, the subject invention comprises a leak detection system. The detection circuitry consists of a water flow venturi; two pressure sensing transducers, an instrumentation differential op-amp circuit and a microprocessor. The two transducers are referred to as P1 and P2, where P1 refers to the inlet pressure transducer, and P2 refers to the throat pressure transducer. The pressure transducers are common 4-20 mA current loop, 0-100 PSI and 10 vdc style transducers. They are powered by a 20 vdc power supply. They have a resister in series with the transducers of approximately 250 ohms. This provides as voltage drop across the resistors of between 1 and 5 vdc. This voltage is fed into the inputs of the instrumentation op-amp. P1 goes to the ‘+’ input, and P2 goes to the ‘−’ input of the op-amp. The gain of the op-amp is set to approximately 5 times, depending on the resistor value used in the transducer circuit, the voltage differential into the op-amp, and the voltage rating of the ADC (analog to digital converter) in the microprocessor. The op-amp is powered by the same 20 vdc power supply as the transducers.

As water flows through the venturi, a pressure differential is created between the inlet and the throat. This pressure is translated into an electrical current by the transducers, each with a slightly different current flow. These current flows are translated into voltages by the series resistors. These voltages are fed into the instrumentation op-amp, which amplifies the difference between the two voltages. This amplified difference can be directly converted into a water flow reading by a simple calculation, which is empirically derived from a series of calibrated measurements. P1, P2 and the flow reading are fed into the ADC's in the microprocessor. The differential amplified op-amp output is used because it allows us to read flow data over the full range of the ADC. Because ADCs only operate over a set voltage range, if only P1 and P2 were digitized and the difference taken, we would have a very low resolution measurement of the flow rate. The op-amp amplifies this difference to a voltage that covers the full range of the ADC, thus providing a higher resolution reading.

The microprocessor takes these voltages and converts them into binary values in the ADC. The microprocessor also has the normal readings for each zone stored in an EEPROM. The normal readings are deduced by taking readings of the normally operating zone over a period of time, with some percentage added for normal fluctuations. The high and low flow readings and pressures are saved and used during future runs to detect when the flow is outside of the normal operating parameters. The flow rate varies with pressure, so the operating flow rate is scaled to a ‘nominal’ flow rate based on the current pressure reading. This allows the unit to continue operating even when the pressure is fluctuating. A zone is shut down if the adjusted flow rate is outside of the preset limits, or if the pressure is outside the preset operating limits. A sensitivity adjustment can be provided that determines the period of time during which a zone can operate outside of its preset limits before being shut down. There is also a time delay between the zone start and leak detection sensing to allow the pipes to fill with water, and for the pressure and flow to stabilize.

In an embodiment, as shown in FIG. 2C, the leak detection circuitry consists of a length of schedule 40 PVC pipe, a pressure sensing transducer 266, a paddlewheel style flow sensor 265 and a microprocessor. Two ¼″ holes are drilled into the PVC pipe and threaded to allow the flow sensor 265 and pressure transducer 266 to be mounted. The pressure transducer 266 is a common 4-20 mA current loop, 0-100PSI, 10-36vdc-style transducer. It is powered by a 20 vdc power supply. It has a resister in series with the transducer of approx. 250 ohms. This provides a voltage drop across the resistor of between one and 5 vdc. The output of the paddlewheel flow sensor 265 is a pulsing 0-5 vdc signal. Each time the paddlewheel does around it generates one pulse. This output is fed into the external interrupt pin of the microprocessor.

As water flows through the pipe, the paddlewheel spins causing a pulsating signal to be applied to the external interrupt pin of the microprocessor. The microprocessor counts the number of pulses that occur each second. This number can be directly converted into a water flow reading by a simple calculation, which is empirically derived from a series of calibrated measurements. The output of the static pressure transducer is fed into the ADC of the microprocessor, which gives us a pressure reading.

The microprocessor also has the normal readings for each zone stored in an EEPROM. The normal readings are deduced by taking readings of the normally operating zone over a period of time, with some percentage added for normal fluctuations. The high and low flow readings and pressures are saved and used during future runs to detect when the flow is outside of the normal operating parameters. The flow rate varies with pressure, so the operating flow rate is scaled to a ‘nominal’ flow rate based on the current pressure reading. This allows the unit to continue operating even when the pressure is fluctuating. A zone is shutdown if the adjusted flow rate is outside of the preset limits, or if the pressure is outside the preset operating limits. A sensitivity adjustment can be provided that determines the period of time during which a zone can operate outside of its preset limits before being shutdown. There is also a time delay between the zone start and leak detection sensing to allow the pipes to fill with water, and for the pressure and flow to stabilize.

In an alternative embodiment, as shown in FIG. 2D, the leak detection circuitry consists of a water flow venturi 110, a static pressure transducer 267, a differential pressure transducer 268 and a microprocessor. The pressure transducers 267 and 268 are common 4-20 mA current loops, 0-100PSI, 10 vdc style transducers. They are powered by a 20 vdc power supply. They have a resister in series with the transducers of approx. 250 ohms. This provides a voltage drop across the resistors of between one and 5 vdc. This voltage is fed into the ADC inputs of the microprocessor. One side of the differential pressure transducer 268 is connected to the throat 256 of the venturi 110, and the other side is connected to the inlet 255 of the venturi 110. The static pressure transducer 267 is also connected to the inlet 255 of the venturi 110.

As water flows through the venturi 110, a pressure differential is created between the inlet 255 and the throat 256. This pressure difference is translated into an electrical current by the differential pressure transducer 268. The current flow is translated into a voltage by the series resistor, which is fed into the ADC on the microprocessor. This voltage reading can be directly converted into a water flow reading by a simple calculation, which is empirically derived from a series of calibrated measurements. The output of the static pressure transducer 267 is also an electrical current, which flows though a 250-ohm resistor, giving us 1-5 vdc. This is also fed into the ADC of the microprocessor, which gives us a pressure reading.

This microprocessor takes these voltages and converts them into binary values in the ADC. The microprocessor also has the normal readings for each zone stored in an EEPROM. The normal readings are deduced by taking readings of the normally operating zone over a period of time, with some percentage added for normal fluctuations. The high and low flow readings and pressures are saved and used during future runs to detect when the flow is outside of the normal operating parameters. The flow rate varies with pressure, so the operating flow rate is scaled to a ‘nominal’ flow rate based on the current pressure reading. This allows the unit to continue operating even when the pressure if fluctuating. A zone is shutdown if the adjusted flow rate is outside of the preset limits, or if the pressure is outside the preset operating limits. A sensitivity adjustment can be provided that determines the period of time during which a zone can operate outside of its preset limits before being shutdown. There is also a time delay between the zone start and the leak detection sensing to allow the pipes to fill with water, and for the pressure and flow to stabilize.

The Microcontroller 112 controls the system operations. In a preferred embodiment, the Microcontroller 112 is designed around the 16C74A Programmable Interrupt Controller (PIC) manufactured by the MicroChip Corporation, but any controller chip such as a Motorola or Zenith could be used. The chip is mounted in a 40-pin low profile integrated circuit socket on the controller printed circuit board (PCB). The printed circuit board is preferably a single layer, double sided board. Other major components such as resistors and capacitors are also mounted on the board as necessary. The printed circuit board is mounted on four insulated standoff mountings at the bottom of the controller case. The controller case is standard. Holes are drilled into the case to mount the connectors.

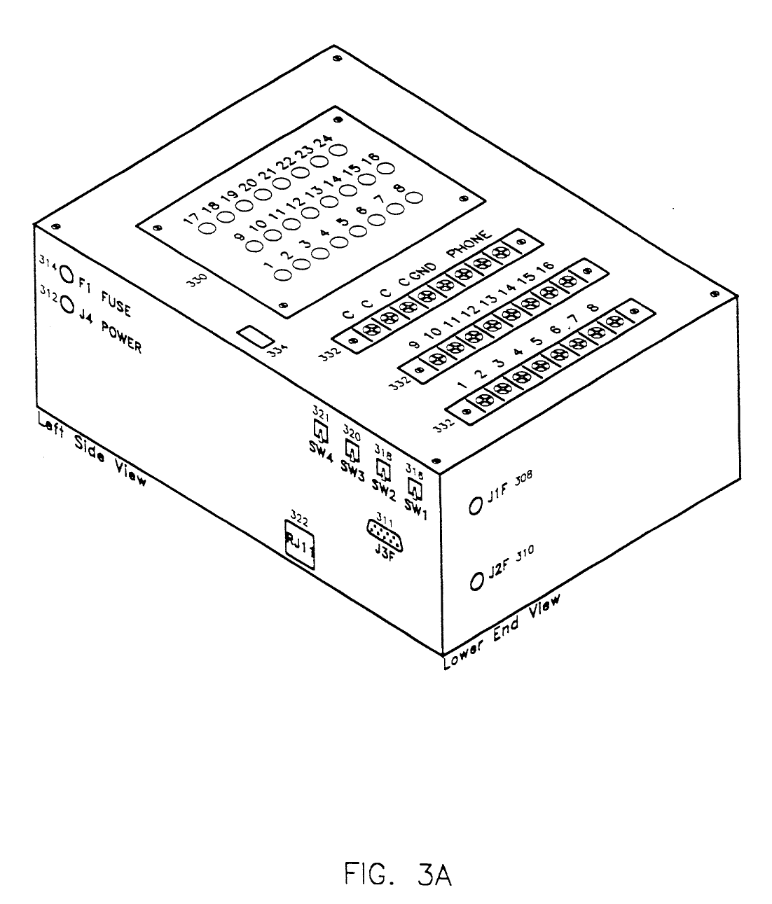

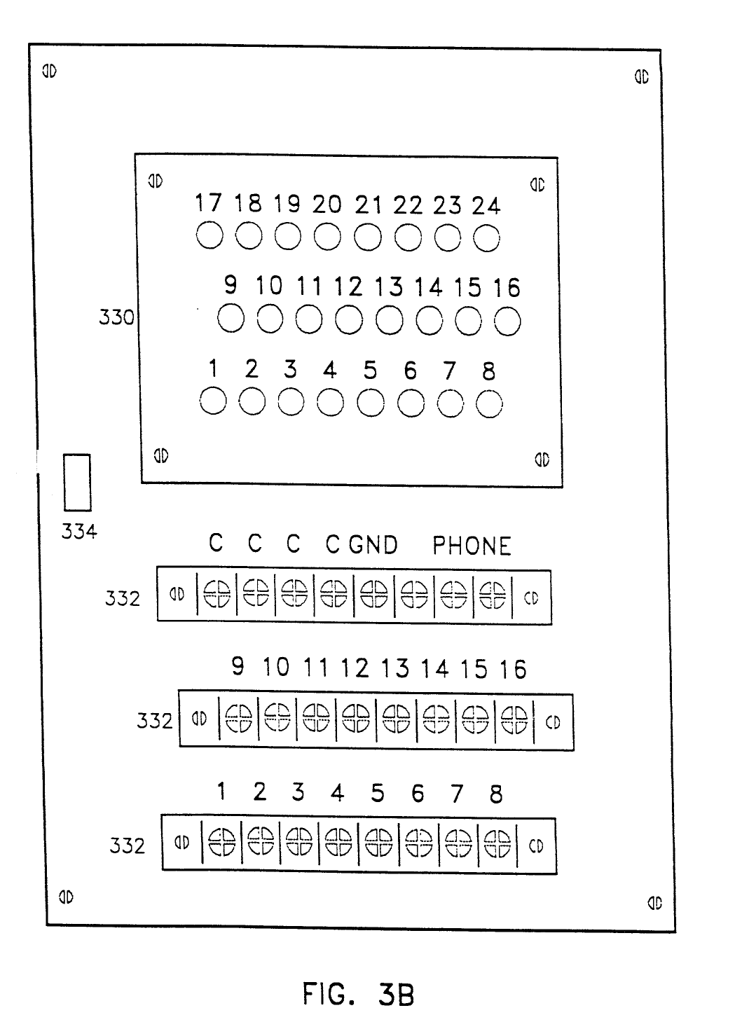

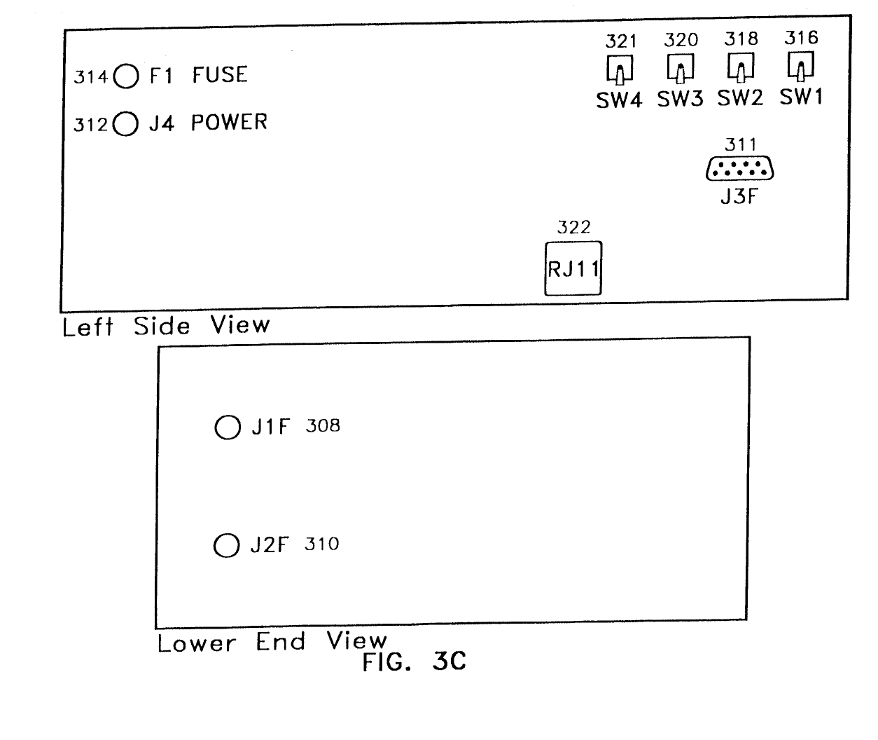

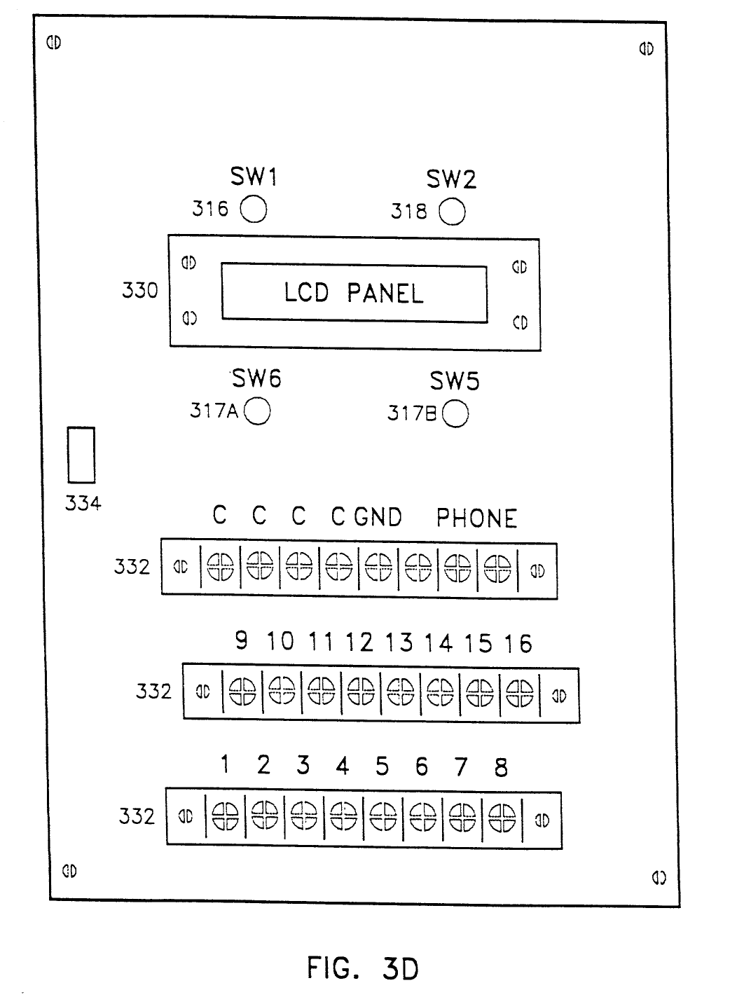

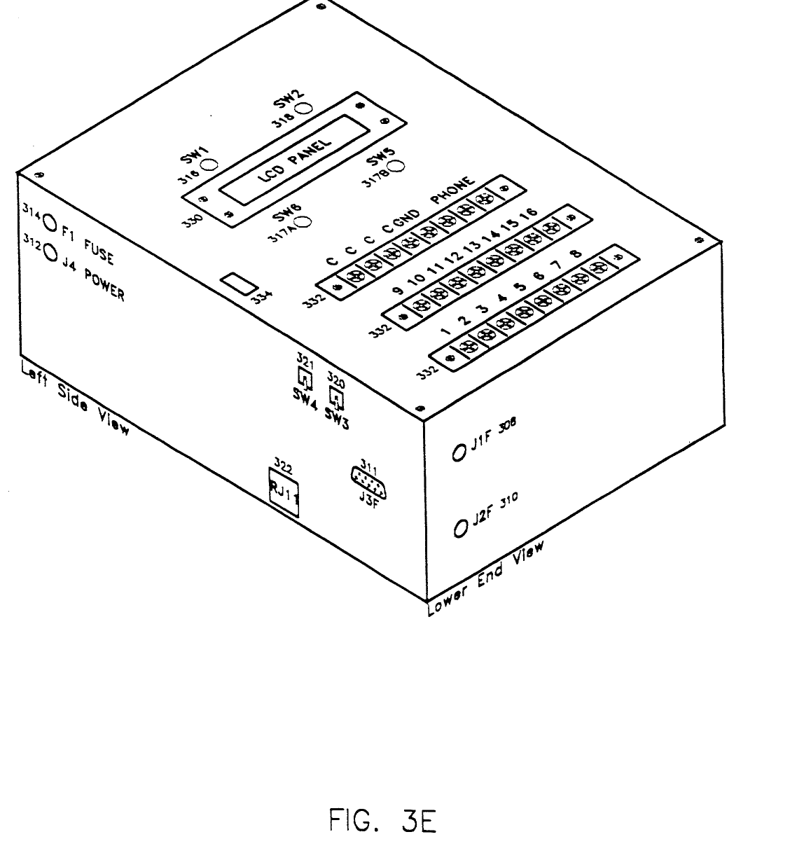

Specifically, as shown in FIGS. 3A and 3C, Connectors J1F 308 and J2F 310 are five-pin DIN connectors used to connect the transducer cables 111 to the Microcontroller circuit board. Connector J3F 311 is a nine-pin connector used to interconnect an external modem or to make a direct RS232 connection to the Microcontroller circuit board. The connector 311 is used with switch SW4 321, which allows the ability to switch between the use of an internal socket modem 104, an external modem or to make a direct RS232 connection from the Microcontroller 112 directly to the host computer. The RJ11 322 is a direct telephone line connection to the modem 104.

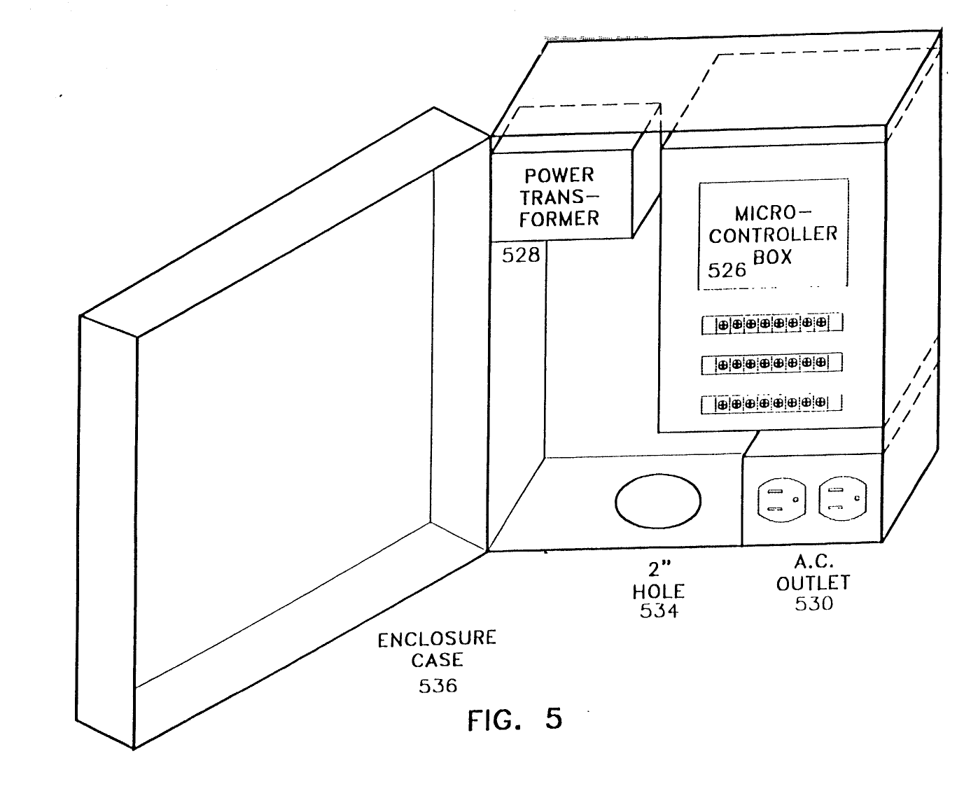

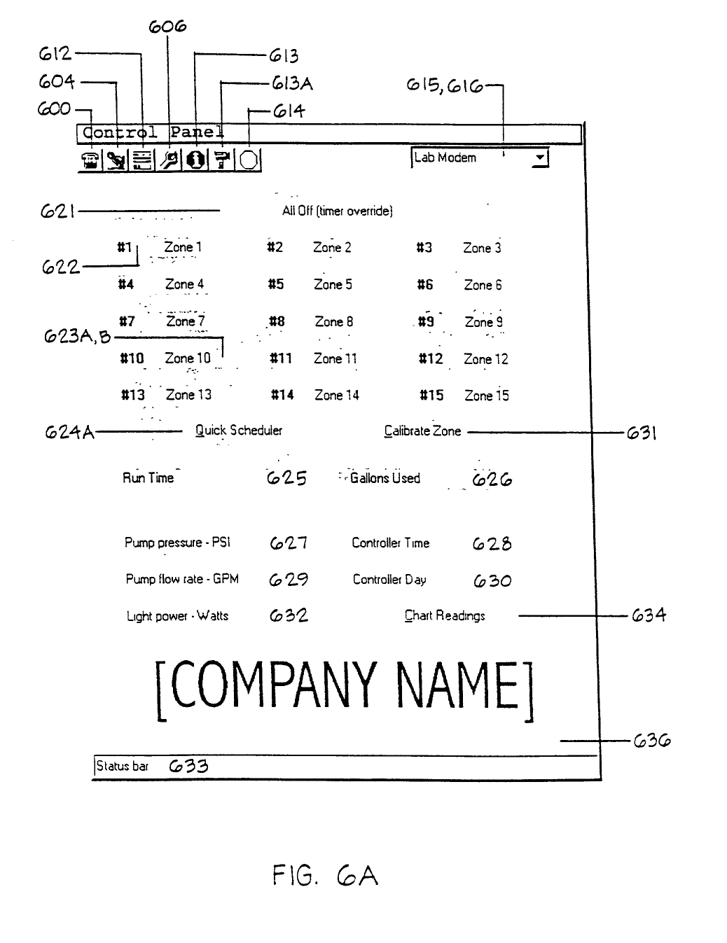

Connector J4 312 interconnects the 12-volt power transformer 528 (FIG. 5) to the Microcontroller 526. Connector F1 314 is a five-amp fuse connector. Switch SW1 316 is a cycle switch that allows the sprinkler irrigation system to be manually switched through the sprinkler zones 122. Switch SW2 318 is a reset switch. Switch SW3 320 is a battery back up off/on switch. A standard Rain Sensor Override is mounted to the Microcontroller box which turns off an operating sprinkler zone 122 when rain is detected.

Referring to FIG. 3A, in the preferred embodiment, the top face of the Microcontroller 112 contains a Light Emitting Diode (LED) panel 330 and three terminal Barrier Strips 332. The LED panel is composed of three rows of eight clear LEDs. The LEDs are an industry standard purchased from any electronics vendor. The LEDs are used as status indicators signifying whether a zone 122 is on or off (operating or not operating). In an alternate embodiment, the LED panel is replaced with a Liquid Crystal Display (LCD) panel as shown in FIGS. 3D and 3E. This alternate feature incorporates an industry standard 20×4 (IIC) LCD module such as one manufactured by Matrix Orbital, but any IIC LCD module will work. In this alternate design, switches 317A and 317B allow the scrolling and control of the LCD screen display. Switches SW1 316 and SW2 318 have been moved to the front panel in this alternate embodiment.

Switch 334 shown on the front face in FIGS. 3A, 3B, 3D and 3E, is a three-position switch functioning as a rain sensor override switch with a rain sensor and an ‘all off’ position. When the switch is in the rain override position, a zone 122 can be turned on whether the rain sensor is activated or not. In the rain sensor position, the sprinklers 124 only function when the rain sensor gauge is not activated. The ‘all off’ position disables all of the zones 122.

The Microcontroller 112 is installed in a waterproof enclosure case 536 as shown in FIG. 5. The enclosure case 536 is designed to sustain various environmental conditions. The other components; AC transformer 528, AC outlet 530 and Microcontroller Box 526, are also installed in this enclosure case 536. When the unit is installed on site, valve control wires are run through an access hole 534 in the bottom of the enclosure case 536. A telephone line is connected to the modem 104 (FIG. 1) and the Microcontroller 112. Transducer lines are connected and the AC power transformer 528 is plugged in.

The Microcontroller 112 interfaces with all devices on the system through software control programs installed on the host computer 102. Once the software programs are installed using standard software installation procedures, they are automatically placed on the start menu of the Windows operating system. The Microcontroller 112 can be accessed by a Personal Computer workstation 102 (FIG. 1) preferably using Windows 9X, Windows 200x or Windows NT operating systems. The Microcontroller 112 is accessed through a modem 104 or like communication means in the personal computer.

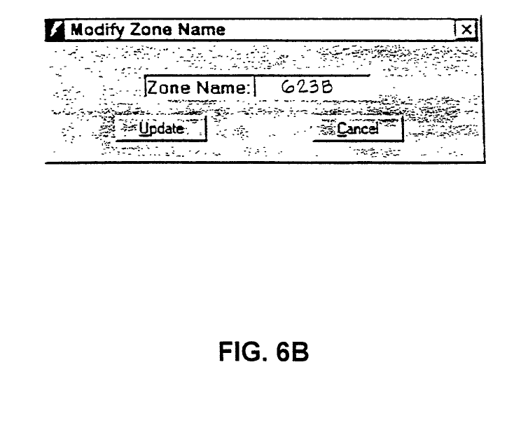

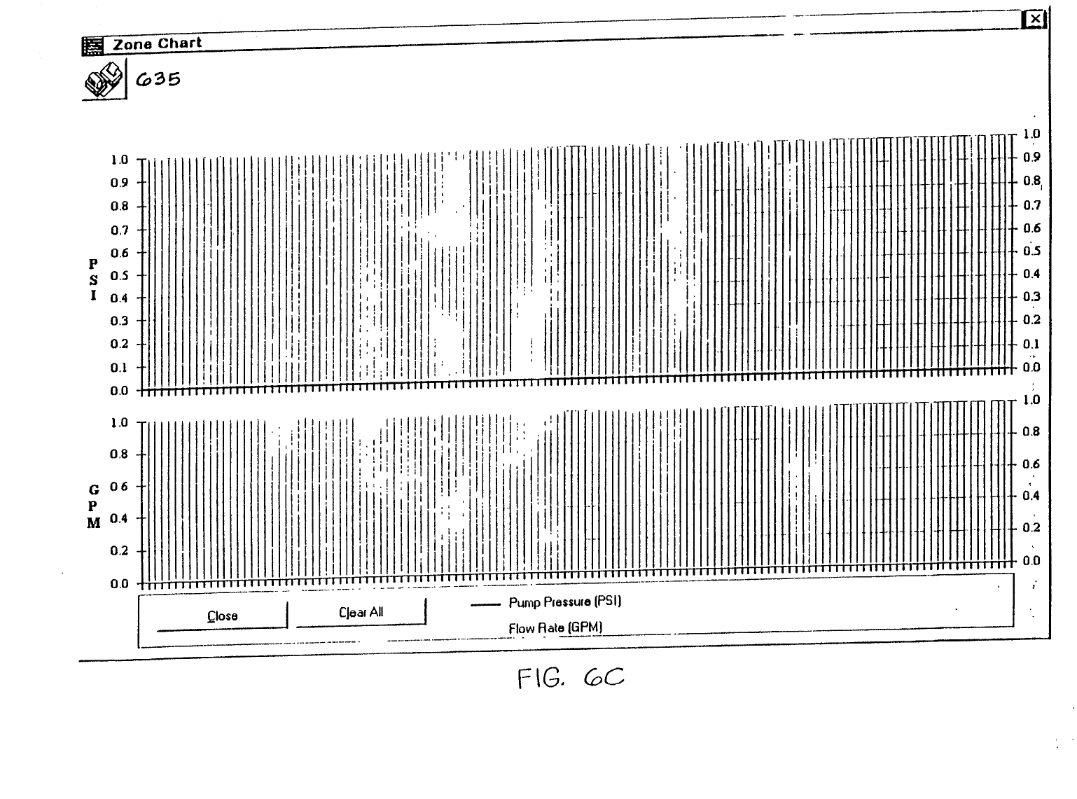

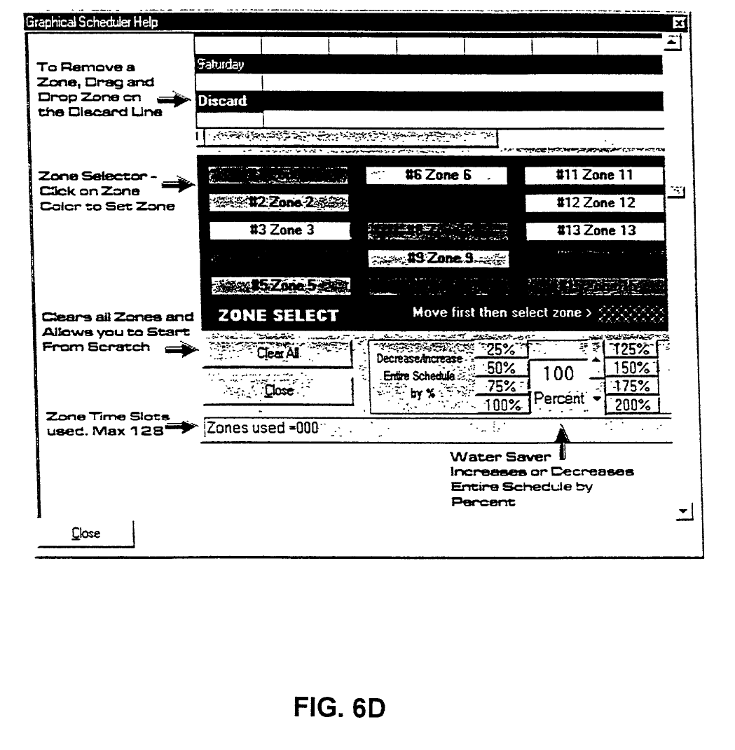

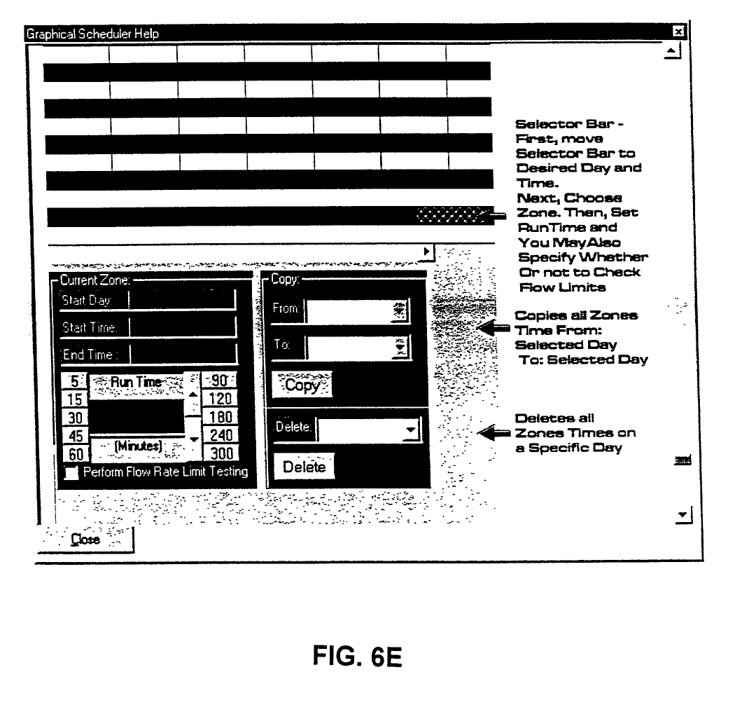

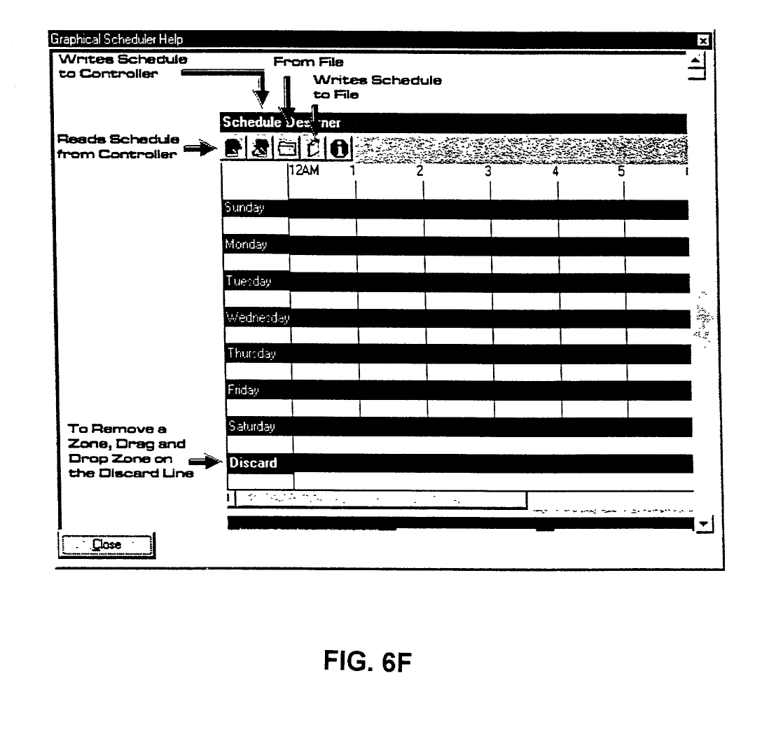

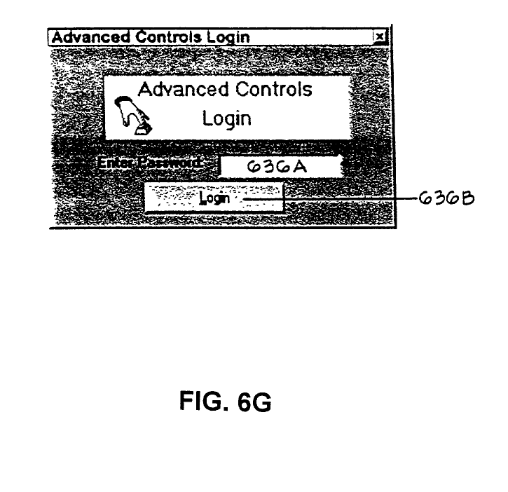

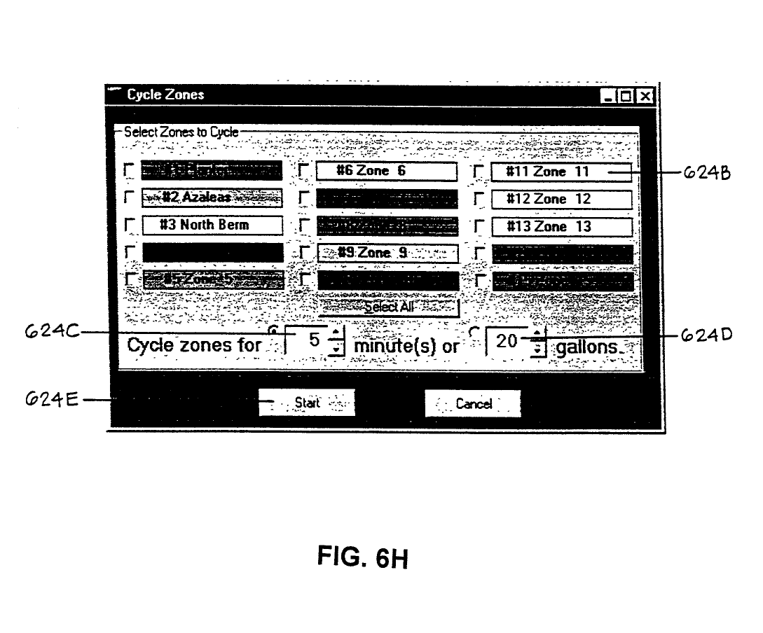

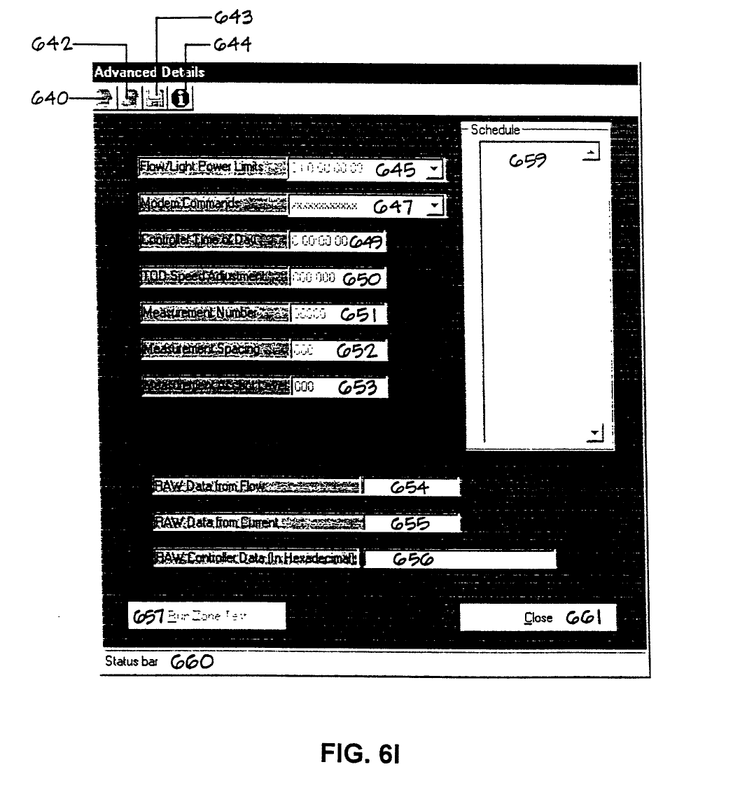

The Control Panel screen, as shown in FIG. 6A, is designed using industry standard Microsoft Windows Operating System format with a company logo, title and software version number. The Control Panel provides access to special functions such as uploading/downloading schedules, setting up the screen, designing sprinkler irrigation schedules or accessing help. The Control Panel also provides the capability to operate the sprinkler irrigation zones manually and observe performance parameters.

To operate the software, the user first clicks on the company shortcut icon located on the computer desktop using a standard mouse, and the Control Panel menu (FIG. 6A) appears on the computer screen. Standard window's icons are used to minimize, maximize, or terminate the session. The Control Panel also has several special icons that allow the user to call the Microcontroller 600, disconnect the session 604, access set up 608, access the Schedule Designer menu 612, or access the help files 613 and 613A.

The Access Telephone button 600 is used to connect to the Microcontroller 112 to send a new schedule or an update an existing schedule. The user, based on seasonal rainfall, local restrictions or environmental conditions, may develop various custom watering schedules to meet specific conditions. An unlimited number of schedules can be saved individually on the host computer hard drive for future use. Since the Microcontroller 112 can only store and use one schedule at a time, when a new schedule is to be implemented, the user clicks on the phone button 600, the computer software program dials via the modem 104 to the Microcontroller 112, which answers, then the user uploads the new schedule to the Microcontroller 112. To end this session, the hang up button 604 is clicked to terminate the connection.

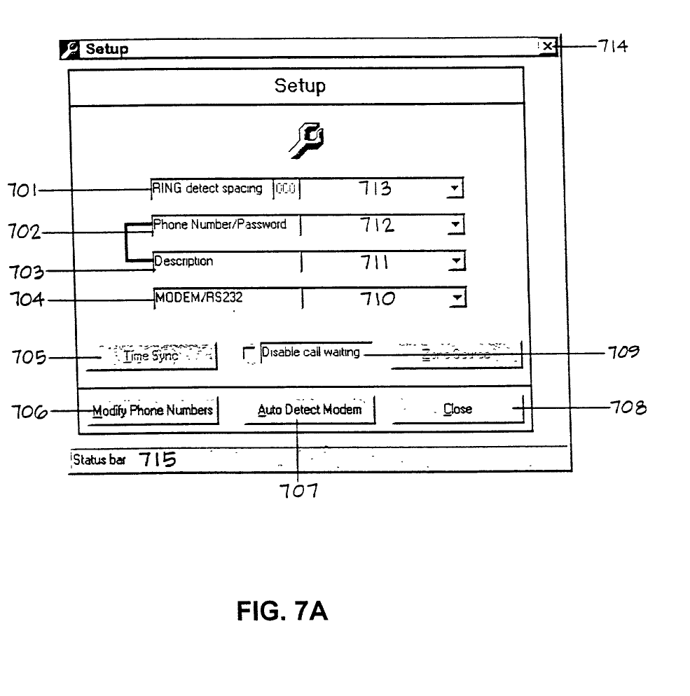

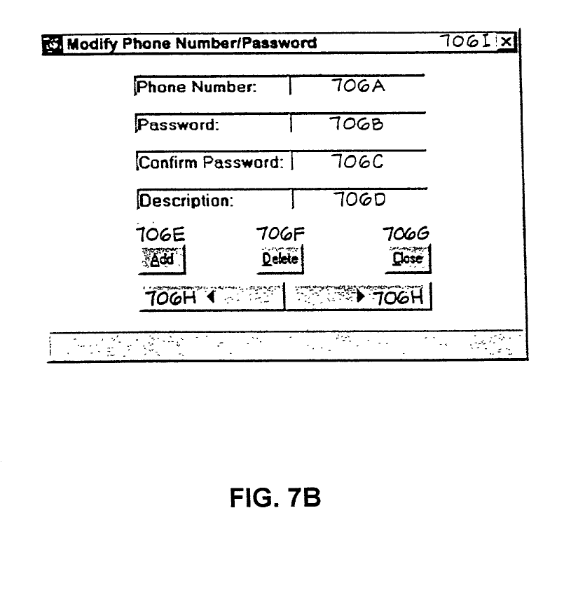

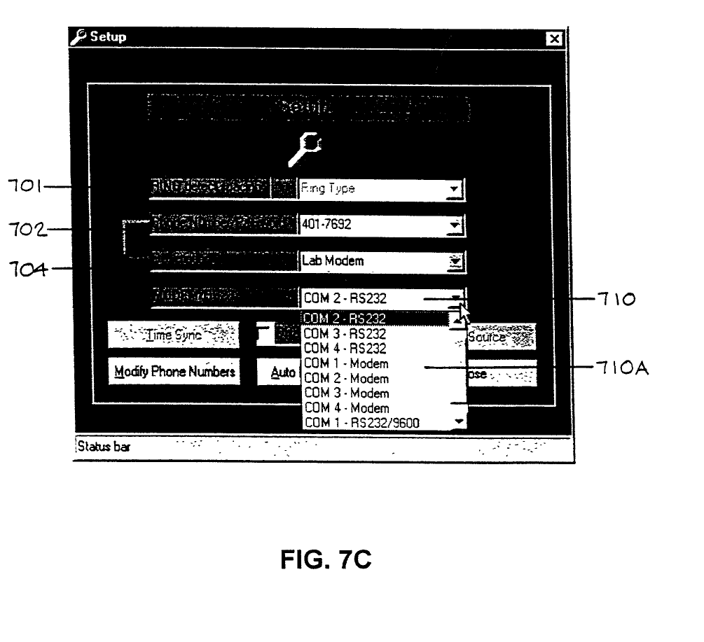

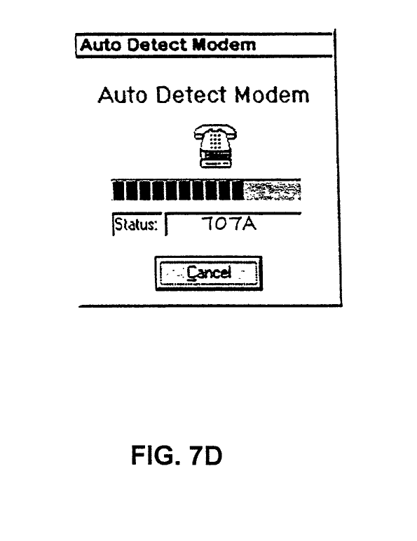

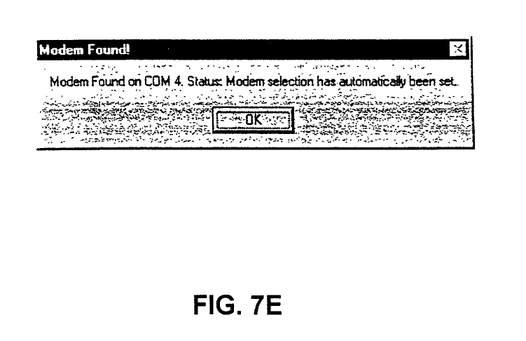

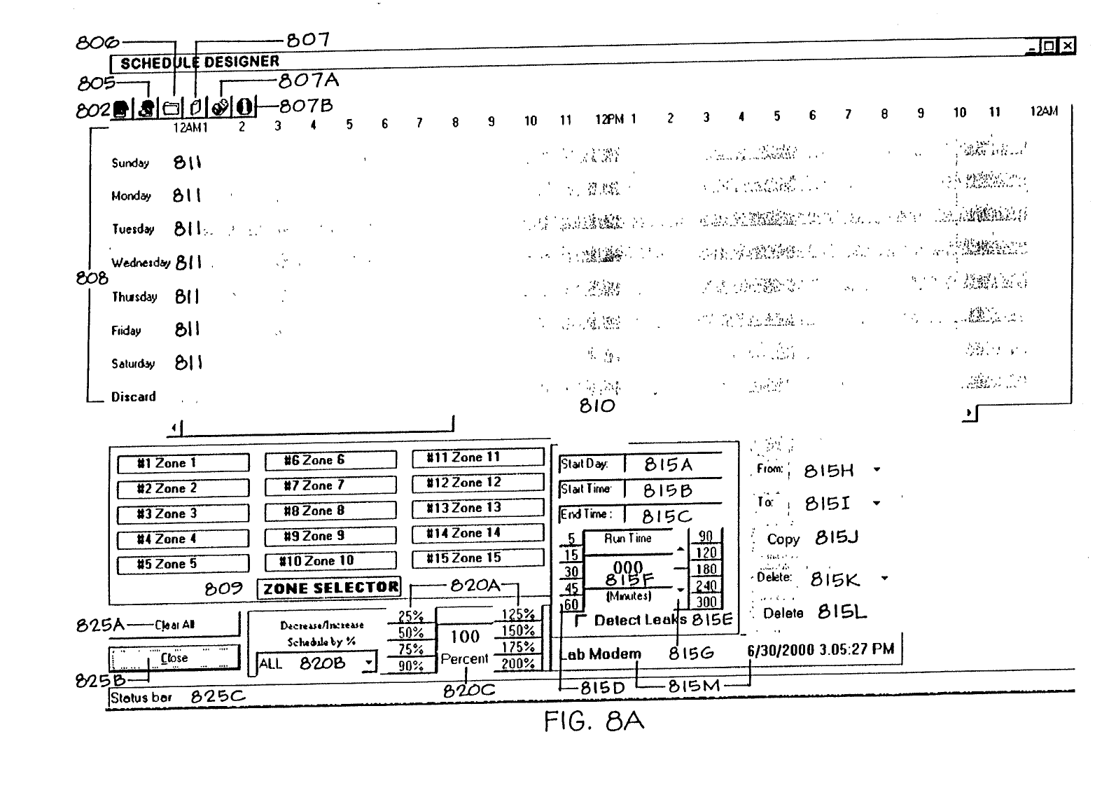

The user can access the Set Up screen (FIG. 7A) from the Control Panel by clicking on the Set Up icon button 606. The set up screen allows the user to set communications parameters and telephone numbers. The Schedule Designer menu icon button 612 gives the user access to this menu, allowing the user to design and develop watering irrigation schedules and designate which zones are to be tested for performance.

The Help icon 613A displays a pre-programmed video clip and demonstrates how to use features on the Control Panel. Text-based help is also available by clicking on Help icon 613. The Stop icon 614 is used to shut the entire sprinkler irrigation system down immediately.

The Location drop down window 615 displays the name of the specific Microcontroller 112 that the computer is connected to. This feature is valuable when the user has multiple Microcontrollers. This window has a drop down list 616 able to accommodate up to six locations.

An ‘All Off’ Timer Override window 621 allows the user to click on this window and manually shut the Microcontroller 112 down immediately. The window is displayed in red when the system is in the manual shut down mode. This feature is also used to override the rain sensor and shut the system down whenever the user desires to.

There are fifteen Zone Number windows 622 and Zone Name windows 623 grouped and displayed together on the Control Panel. Each Zone Number is one of fifteen physical zones that are hard coded into the system. The current system supports up to 15 zones, but the proprietary software can be programmed to accept a greater number of zones. The zones can be a combination of either sprinkler zones or light zones. The sprinkler zones normally start from zone one, and light zones begin with zone 13, but this is software programmable option based on end user preferences. Depending on the layout, zones one through twelve could be sprinkler zones and 13 through 15 could be light zones. The Zone Name dialog boxes 623A display the names of the current zones programmed into the system. The default name is the corresponding Zone Number as shown in FIG. 6A, zones 2 to 15. Each Zone Name can be modified by clicking on the Zone Number 622 to the left of the Zone Name. A ‘Modify Zone Name’ dialog box appears on the screen (FIG. 6B). The user changes the Zone Name 623B, then clicks on the update button and the name is changed. The dialog box disappears and the Control Panel window reappears. Users can create unique zone names that identify their system layout rather than using just numbers. This feature is very valuable in large commercial applications when using multiple Microcontrollers with the need to identify specific locations. In this situation, the zone names change as they select a different Microcontroller.

The Zone Name 623B is displayed in green (color may vary) when the zone is in operation. If the system detects a defective zone 122, such as a broken sprinkler head, the zone 122 is shut down and displayed in red (color may vary). The next time the zone 122 is scheduled to run, it is first tested and if there is still a problem, it is again shut down and displayed in red. A zone can also be turned on manually by clicking on the Zone Number 622. While the zone 122 is running under manual control, the user can calibrate the zone by clicking on the Calibrate Zone button 631. During this calibration mode, the system automatically sets the zone high and low flow limits. A special Cycle Zone mode can cycle through and run each zone for one minute. This is done by clicking on the Cycle Zone button 624A and the Cycle Zone window appears (FIG. 6G). The user can then select the zone 624B, the run time 624C in minutes, or specify the number of gallons 624D to be distributed. Then the user clicks on the start button 624E to start the cycling process.

While the host computer 102 is connected to the Microcontroller 112, the user may review each zone's 122 usage data displayed on the Control Panel (FIG. 6A) such as: run time, gallons used, pump pressure/flow system time and power consumption. The Run Time window 625 displays the elapsed time in minutes a zone has been running. The Gallons Used window 626 displays the gallons of water used during the indicated run time of the zone. Pump Pressure and Pump Flow Rate are also monitored by the system. The Pump Pressure 627 and Pump Flow Rate 629 readings are sent to the host computer and displayed on the Control Panel. The Pump Pressure is monitored by the Microcontroller and displayed in the Pump Pressure window 627 in pounds per square inch (PSI). The readings provide real time information on any changes where a low-pressure reading may indicate a break or an open line, and a high-pressure reading may indicate problems with a valve or valve circuits not operating properly. On residential or commercial applications that are not on a pump or well, this reading indicates the pressure and flow of the city or county water pressure. The Microcontroller 112 also monitors the line flow rate or system flow rate. The gallons per minute (GPM) the system is using is displayed in the Pump Flow Rate window 629.

Electrical lighting such as pool lights, security lights, and landscape lights can be controlled by this system. The Light Power window 632 indicates the power consumption in watts of the devices monitored. The system is capable of controlling multiple zones that can be divided up to control or manage any combination of lights or sprinklers. In this example, only one zone is used to control lights. The amount of power that is being consumed by the Light zones is continuously monitored by the system. The window is displayed in green (color may vary) when lights are operational.

Additional uses for this invention include, but are not limited to, the control and management of water in ponds or lakes, swimming pools, interior lighting, alarm systems, and monitor environmental controls (HVAC).

The Chart Readings button 634 is used to generate a graphical chart of the Pump Pressure and Pump Flow Rate readings as a graphical display shown in FIG. 6C. This graphical display can be printed by clicking on the Print button 635.

The Microcontroller 112 has a built in system clock that supports all internal functions. This is an important function since the Microcontroller 112 must maintain the correct time to operate the sprinkler irrigation schedule at the precise times. When the user accesses and logs on to the Microcontroller 122, the Control Panel will display the Controller Time 628 and the Date 630. If the time is displayed in red (color may vary), this indicates the Microcontroller 112 and the host computer 102 are not coordinated. To correct this condition, the user clicks on the Controller Time window 628, a time window appears and the Microcontroller 112 time is automatically synchronized.

A special Advanced Details tab 636 is featured on the Control Panel to provide access to a password protected window that allows only authorized service personnel to set up and make changes to the advanced setup parameters. This window was designed for service personnel and the installation personnel who need to change advanced system settings. Authorized personnel access the Advanced Details login screen from the Control Panel (FIG. 6A) by clicking on the Access Tab 636 located at the bottom right side of the control panel where an Advanced Controls Log-in screen appears (FIG. 6G). The user then enters a password 636A and clicks the Login button 636B. The Advanced Details screen appears (FIG. 6I). A row of icon buttons located on the top left of the Advanced Details screen allows the user to read a schedule from the Microcontroller 640, write a schedule to the Microcontroller 642, download data from the Microcontroller 643, or obtain additional information on the Advanced Details screen 644.

The Advanced Details screen also provides the ability to set or establish operating parameters of the system. Operating limits for water flow or electrical flow can be controlled by the limits specified in the Flow Light Power Limits window 645. Special Modem Commands strings 647 can be selected from a drop down window. The system normally has four command strings available, two dial commands that the Microcontroller uses to dial out preprogrammed numbers in case of an emergency. One other number is used as needed. The last is a modem initialization string to set up the internal modem.

The Microcontroller Time of Day can be set using the Controller Time of Day window 649. To adjust the clock running speed, the user can enter values in the TOD Speed Adjustment window 650 to speed up the clock or slow it down.

The number of measurements the Microcontroller 112 has stored in its EEPROM memory is displayed in the Measurements Number window 651. The spacing between the measurements can be determined by entering the values in the Measurement Spacing window 652. The number entered represents seconds. For example, an entry of five would take readings every five seconds. The Measurement Accept Level 653 establishes the minimum pressure reading in pounds per square inch (psi). This would normally be any number greater than zero in order to take readings. A zero would indicate that no readings are to be taken. During trouble shooting and analysis situations, it may be necessary for the manager, technician or engineer to look at real (raw) data readings from the Microcontroller(s). In these cases, raw data can be viewed in the Raw Data from Flow window 654, Raw Data from Current Zone 655, or the Raw Controller Data displayed in the Hexadecimal format 656. A group of five different readings (P1, P2, Flow, Wattage and Adjusted Flow) is displayed in this window.

The manual Run Zone Test button 657 is used to initiate a zone test. Once started, the test runs each zone for one minute then automatically sequences to the next zone until all zones have been run and tested.

The Schedule Designer screen is normally used to view a watering schedule, but in an analysis of a problem, the schedule can be viewed in a decimal format in the Schedule window 659.

A system Status Bar 660 is used to display process messages or error messages incurred during the use of the Advanced Details screen or during testing. Close button 661 closes this window and returns to the Control Panel screen (FIG. 6A).

A Status Bar 633 is located at the bottom of the Control Panel to display operating status messages such as “connected successfully” when connecting to the Microcontroller 112, “successfully disconnected” when the session is completed, and other status messages that are relevant at the time.

A Setup screen is accessed from the Control Panel (FIG. 6A) by clicking on the Set Up icon button 606. The Setup Screen, shown in FIG. 7A, allows the user to input initial communications parameters so the computer can communicate with the Microcontroller 112. Three text windows and associated drop down menu boxes are displayed in the center of the setup screen allowing the setup of communication parameters such the ring spacing, Microcontroller phone number, a description and modem type.

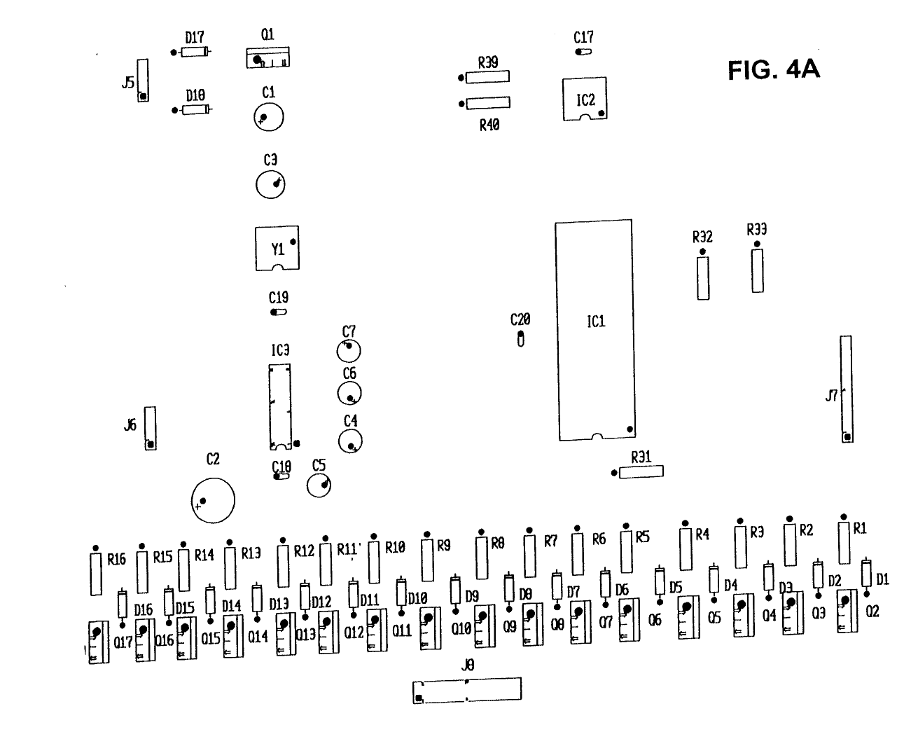

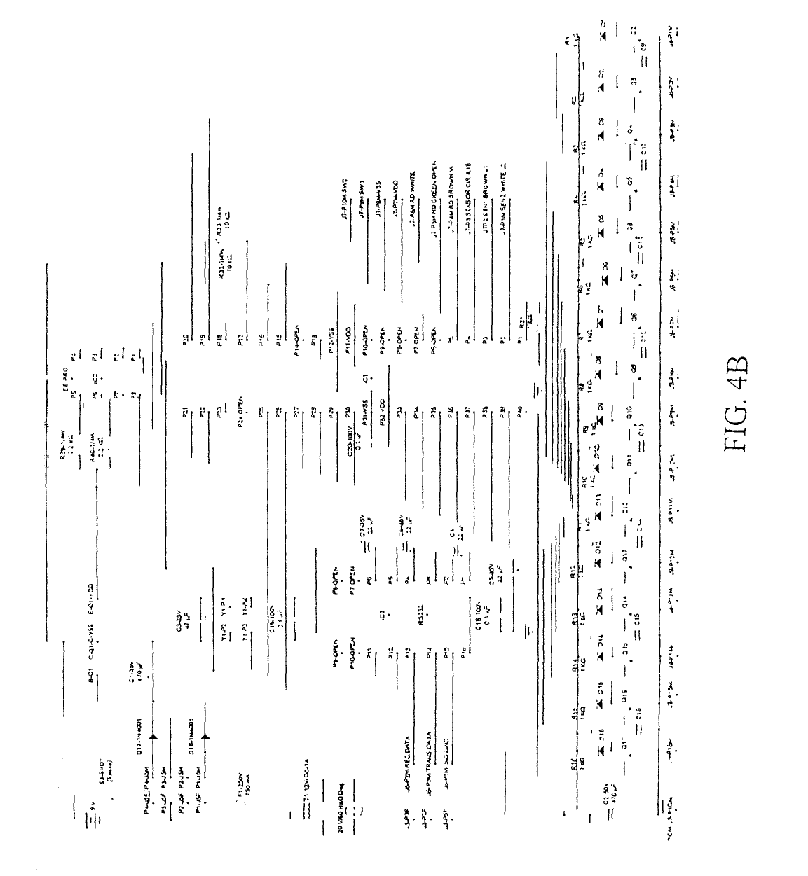

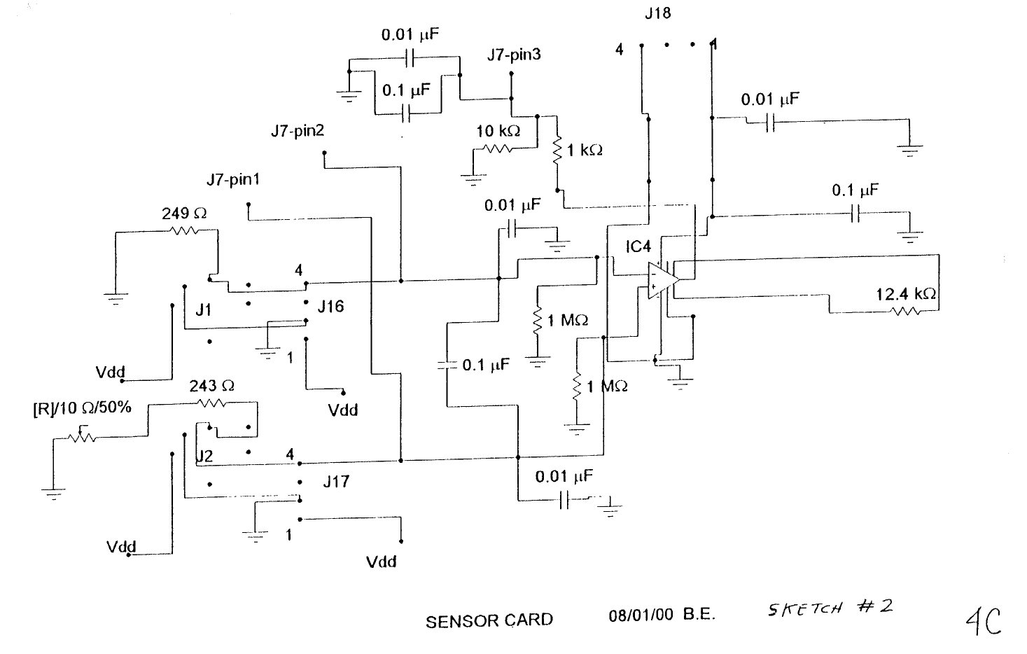

Ring Detect Spacing 701 is an option to choose from various types of ringing patterns. The user can use an existing residential or business phone line for the Microcontroller 112. The user may request selective type ringing for this line. The Microcontroller 112 has a special ring detector circuit on the main circuit board (FIG. 4A) so when a call is received, the Microcontroller 112 can distinguish by the type of ring if it is specifically for the Microcontroller 112. The Ring Type down menu 713 is used to program the Microcontroller 112 to answer to a specific ring with the selected spacing.

The Phone Number/Password window 702 and a drop down menu 712 provide the capability to set up or modify a telephone number and password. This information is used by the software program to dial the Microcontroller 112, and the Microcontroller 112 uses this information to authorize the caller. The information is entered into the drop down menu field 712 in a specific format and decoded by the Microcontroller 112. Several phone numbers can be programmed into the software program providing the ability for one host computer to act as a Central Control and communicate with other Microcontroller 112 locations. The Description Field 703 and drop down Text field 711 provide a means to create a description and specific location for the telephone number and password. The user may modify or change the phone number/password by clicking on the Modify Phone Number button 706, where a Modify Phone/Password window appears (FIG. 7B) displaying fields to add 706E or delete 706F the existing information. A Phone Number window 706A allows the user to modify the telephone number. The modification must be confirmed by a Password 706B and Confirm Password 706C windows. A window to add a Description 706D is also available. A slider bar 706H allows the user to scroll through a long list of information. The modify phone number can be closed either by clicking on the close 706G button or clicking on the standard close icon 7061 on the top right hand comer of the screen.

The type of interface can be established as either a modem connection or a RS232 direct cable connection. The method used depends on the user's preference to connect using a telephone line or if they are close enough to the Microcontroller 112 to use a RS232 cable and connect a computer directly to the Microcontroller 112. The Modem/RS232 Text field 704 and a drop down window 710 are used to select the communications port and the interface type. Once the user clicks on the Modem/RS232 drop down window 710, a list of communication ports and interface types are presented (FIG. 7C) providing the choice of interface connections. The user then makes a selection from the list 710A. The Auto Detect Modem button 707 may be selected to automatically determine the port and interface type. The Auto Detect Modem window displays (FIG. 7D) and the software analyzes the computer resource setting to find the communications port and the associated modem. A Status window 707A displays the status of the detection operation. Once the modem has been detected, the software then displays the modem found (FIG. 7E) indicating the modem and port settings that have been found. If the communications port or modem were not found the software would have generated an error message ‘modem not found’ or ‘communication port not found’.

To synchronize the host computer time with the Microcontroller 112 time, the user clicks on the Time Sync button 705 and the host computer sends the time to the Microcontroller 112. This task must be done while logged on to the Microcontroller 112. To disable the Call-waiting feature on the Microcontroller telephone line, the user clicks and checks the Disable call waiting window 709.

A Status Bar 715 located at the bottom left of the Setup screen displays activity messages and error messages incurred during a connection with the Microcontroller 112.

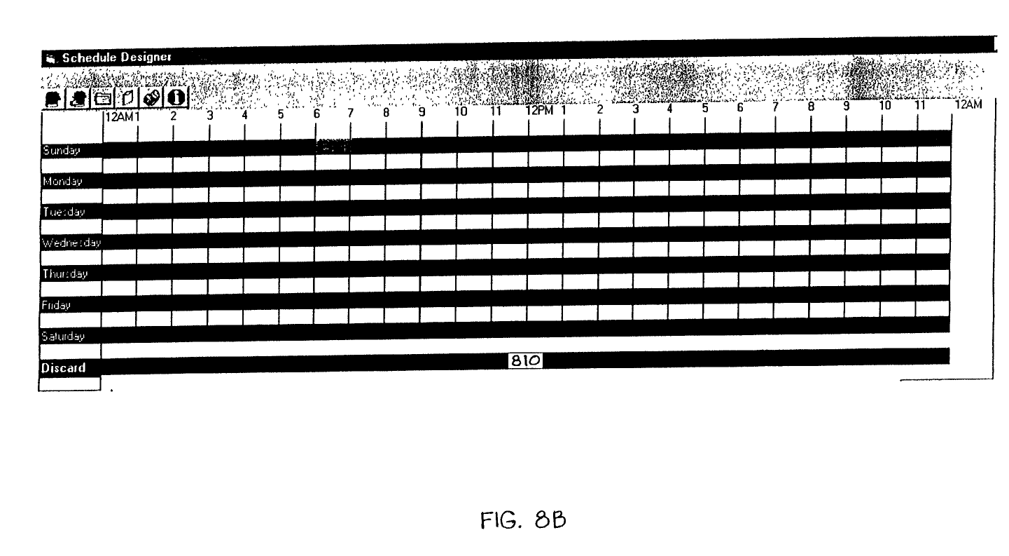

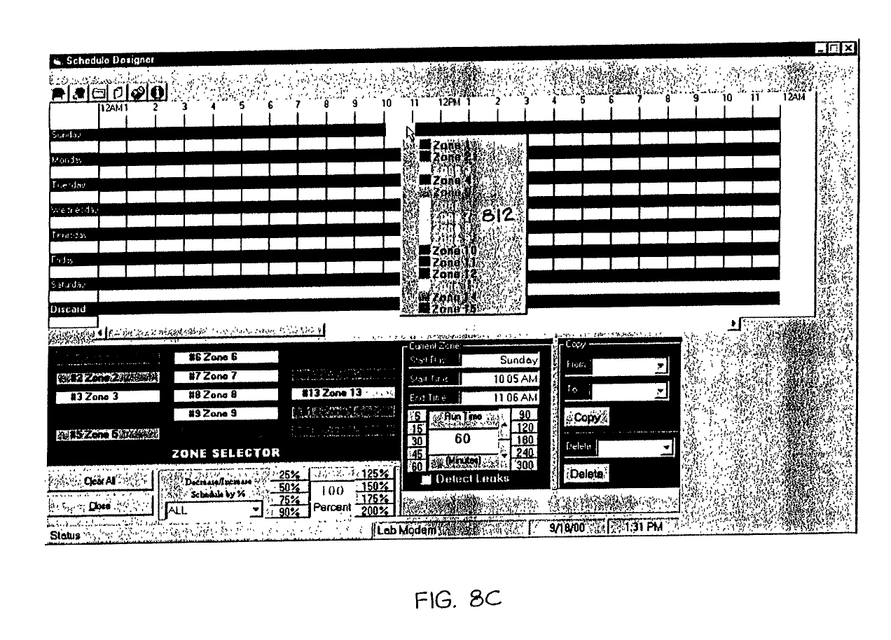

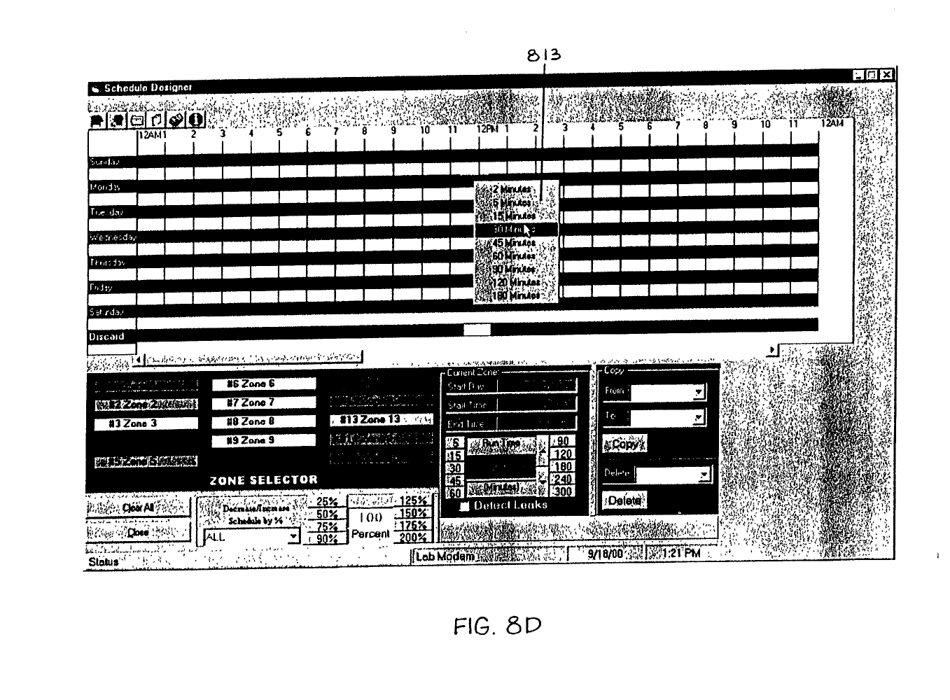

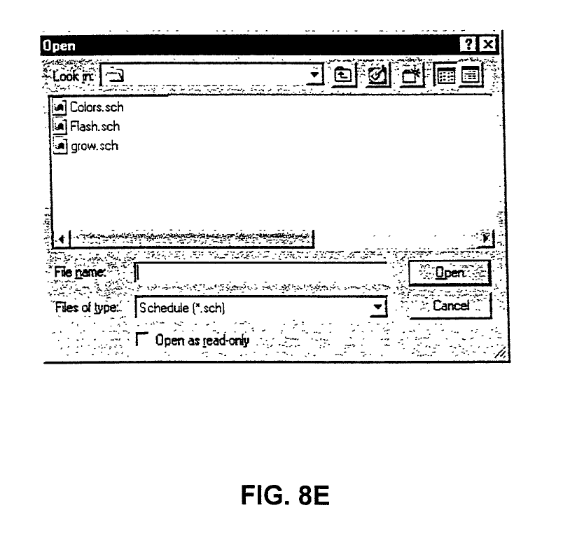

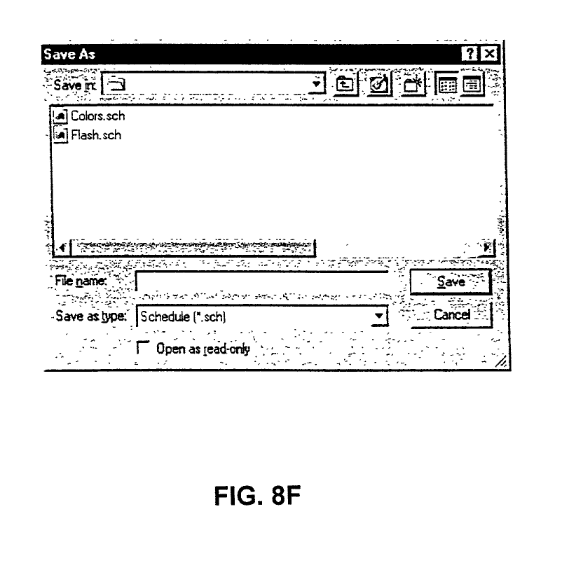

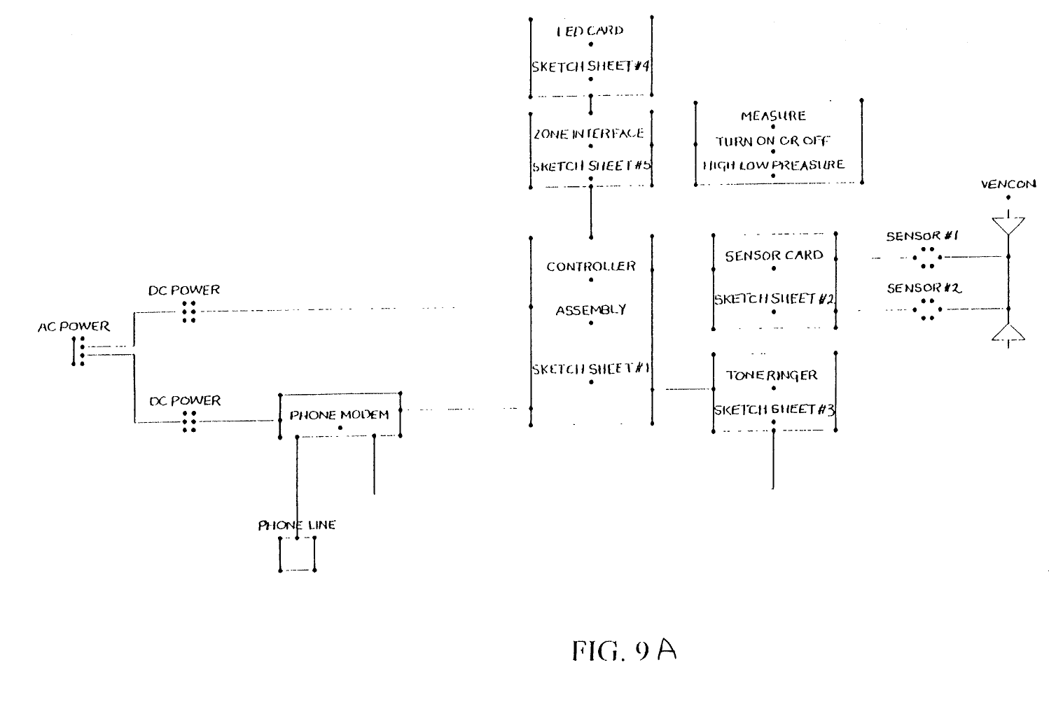

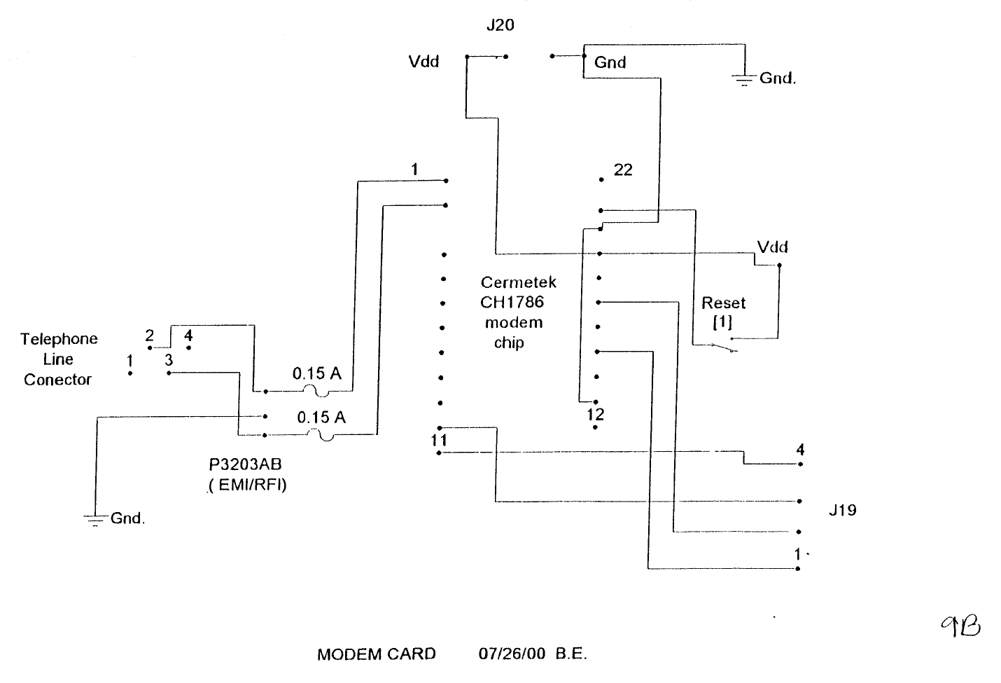

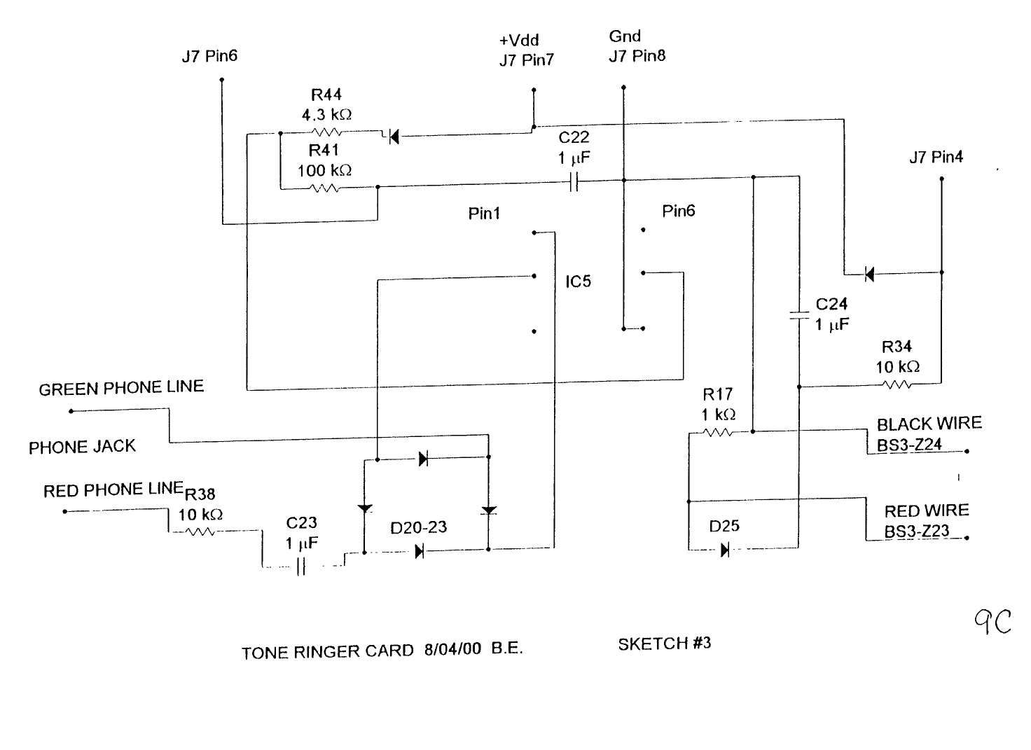

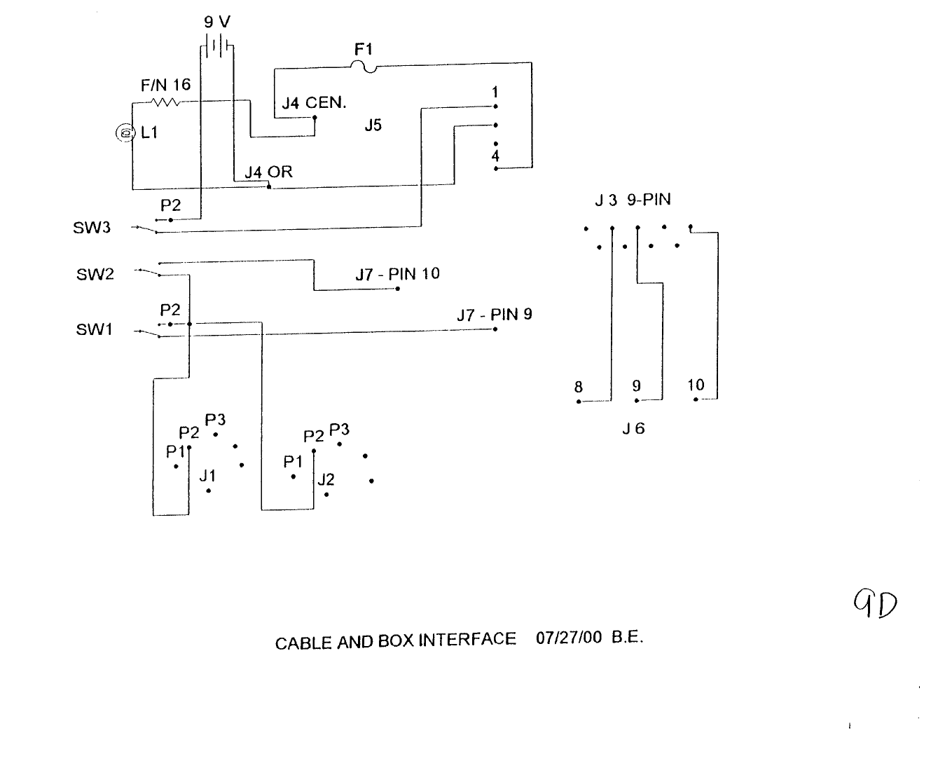

The Schedule Designer window provides the user the capability of designing and creating sprinkler irrigation watering schedules. The screen is accessed from the Control Panel (FIG. 6A) by clicking on the Schedule Designer icon button 612. The Schedule Designer screen (FIG. 8A) is very user friendly and eliminates the frustration of manually manipulating buttons, switches, knobs or keys during the scheduling of a zone. Instead, the user can use click, drag and drop skills standard in Windows software applications to create a schedule.

The Schedule Designer screen is composed of several functional areas: the top of the screen consists of a series of icon buttons, a Schedule matrix, a Zone Selector area with a graphical color display of each zone, a Control and Copy Zone area, and a Water Budgeting area. Referring to FIG. 8A, the Schedule Matrix 808 is a 7-row by 24-column matrix with the days of the week (Sunday through Saturday) displayed vertically on the left of the screen, and a 24-hour time period from 12 a.m. to 12 a.m. displayed in hourly segments horizontally across the top of the screen. A horizontal bar associated with each day is also displayed across the 24-hour time columns of the screen. Each horizontal segment of this bar and a time increment above it forms a Time Slot 811 (FIG. 8A). The entire matrix allows the capability to schedule 128 1-hour time slots, or a nearly unlimited number of shorter run times. A schedule is initially created by left-clicking on the Selector Bar 810 (FIG. 8A), holding the mouse button down and dragging the Selector Bar to a specific time slot, then releasing the mouse button where the Selector Bar then remains in the selected area. The Selector Bar remains neutral in color (white, but color may vary) until a zone is assigned to the Time Slot 811. As each zone is selected, each segment of the Selector Bar color changes to match the color of the assigned zone. The length of each color segment is relative to the time increment for the Zone Run Time. The Selector Bar is preset to a 1-hour run time, but may be easily set to any length of time using the Current Zone function. For example, the Selector Bar for a zone running 30 minutes will be longer in length than one for a zone that has a run time of 15 minutes. The user can designate the time period (run times) for each zone of the schedule.

FIG. 8A shows the Zone Selector area 809 of the Schedule Designer screen. This area presents a graphical display of all of the sprinkler zones on the system. The zones shown are displayed in numerical format but if the user creates custom names for the zone, the Zone Name will display instead of the default Zone Number. The zones are also displayed in different colors as shown in Table 1, although any color may be assigned to a zone by the software programmer.

TABLE 1
DEFAULT ZONE SELECTOR COLORS

| Zone Number | Zone Color |
|---|---|
| 1 | Red |
| 2 | Green |
| 3 | Yellow |
| 4 | Blue |
| 5 | Orange |
| 6 | Light Purple |
| 7 | Brown |
| 8 | Grey |
| 9 | Dark Grey |
| 10 | Tan |
| 11 | Dark Purple |
| 12 | Dark Grey |
| 13 | Pearl |
| 14 | Medium Purple |
| 15 | Mustard |

To select a zone 122, the user clicks on a specific zone and the color associated with that zone now appears in the selected Time Slot 811 (FIG. 8B). Since the run times have not been set, the zone color will show the 1-hour time segment. FIG. 8F shows the Current Zone window and the Copy window portions of the Schedule Designer. The Current Zone window allows the user to set the exact run time for a zone. When the Current Zone first displays, it shows the Start Day 815A, Start Time 815B, and End Time 815C, all in the same color as the selected zone. The total run time for the zone is also displayed in the Run Time window 815F. The user adjusts the Run Time for a zone by clicking on one of the Time Interval buttons 815D for a specific amount of assigned Run Time, or by using the mouse and clicking a Slider Bar 815G to adjust the time increment. The Run Time can be set for a range from one minute to 1,339 minutes using either of the two described methods. Using either of the procedures just described, the user can select and adjust the Run Times for each zone. An alternate method provides the user with the option of selecting a zone and run time by right clicking on any Time Slot 811 in the Schedule Matrix. A drop down menu 812 appears (FIG. 8C) and a specific Zone Number is selected. Once this zone is selected, the user again right clicks on the Time Slot and another drop down menu 813 appears (FIG. 8D) allowing the Run Time for the zone to be selected.

The Copy window (FIG. 8F) copies a schedule from one day to another day. For example, to copy the Sunday schedule to Wednesday, the user clicks on the From drop down menu tab 815H where the days of the week appear. The user then clicks on the day to copy from then clicks on the To drop down menu tab 815I where the days of the week again appear. The user selects the day to copy to, and then clicks on the Copy button 815J, and the process is completed. The copied schedule appears on the Schedule Matrix screen across the horizontal line below the assigned time slot.

The Delete window function provides a means to delete a day of the week time slot or a horizontal segment if needed. The user clicks on the Delete drop down menu tab 815K where the days of the week appear. The user then clicks on the desired day to be deleted and clicks on Delete button 815L to complete the delete process.

FIG. 8A also shows the Water Budgeting window portion of the Schedule Designer.

This window provides the capability to increase or decrease the amount of water to a zone on an incremental percentage basis from 5% to 200%. This is accomplished by clicking on the desired percentage buttons 820A, or by clicking the Up or Down scroll arrows 820B, then holding that arrow until the desired percentage amount appears in the percent window 820C.

Several other buttons and a display bar also appear in FIG. 8A. These are the Clear All button 825A, the Close button 825B and a Status Bar 825C. The Clear All button 825A clears the Schedule Designer screen of any previously scheduled information. This is used when the user wants to completely clear the screen. The Close button 825B closes the Schedule Designer window. The Status Bar 825C located at the bottom of the Schedule Designer screen displays system error and status messages. The Status Bar also displays the amount of time slots that are available for scheduling.

Once a schedule has been developed, a series of five icons on the top left of the Schedule Designer screen (FIG. 8A) allow users to upload or download a schedule to or from the controller, or save a schedule to the host computer's hard drive, or print the current schedule. The Read icon 802 allows the user to read the current watering schedule from the Microcontroller 112. The Microcontroller 112 can only implement one schedule at a time. To change a schedule, the user can write and send a new schedule to the Microcontroller 112 at anytime during a communications session by clicking on the Write icon 805. This feature allows the ability to implement a variety of custom schedules that may have been developed for special purposes such as a seasonal plant or grass requirements, weather, water restrictions, et cetera.

The Open icon 806 provides access to all schedules that have been saved to the hard drive storage area of the host computer (PC). To access previously saved schedules, click on the Open icon 806 and the Open window appears as shown in FIG. 8E. The Open window is an industry standard Open window format found in all Windows applications. It displays the directory where files are stored, the file names and the file type. The user selects the desired schedule by double clicking on the file name. Once the file is opened it is displayed on the Schedule Designer screen where it can be modified, changed or sent to the Microcontroller 112.

The user can design and save an unlimited number of watering schedules by either creating a new schedule or renaming and modifying an existing schedule using the Schedule Designer screen, then clicking on the Save As button 807 (FIG. 8A) and the Save As screen (FIG. 8F) appears. The Save As screen is an industry standard screen and allows options to save schedules in a specific directory on the host computer's hard drive or to another drive. The user then chooses a unique file name for the schedule and clicks on the Save button to complete the save file process.

1. Simplified Example of Preferred Operation

In operation, the user first clicks on the company shortcut icon located on the computer desktop using a standard mouse, and the Control Panel menu appears on the computer screen. Standard Window's icons are used to minimize, maximize, or terminate the session. The Control Panel also has several special icons that allow the user to call the Microcontroller, disconnect the session, access set up, access the Schedule Designer menu, or access the help files .

The Access Telephone button is used to connect to the Microcontroller to send a new schedule or an update an existing schedule. The user, based on seasonal rainfall, local restrictions or environmental conditions, may develop various custom watering schedules to meet specific conditions. An unlimited number of schedules can be saved individually on the host computer hard drive for future use.

The user can access the Set Up screen from the Control Panel by clicking on the Set Up icon button. The set up screen allows the user to set communications parameters and telephone numbers. The Schedule Designer menu icon button gives the user access to this menu, allowing the user to design and develop watering irrigation schedules and designate which zones are to be tested for performance.

The Help icon displays a pre-programmed video clip and demonstrates how to use features on the Control Panel. Text-based help is also available by clicking on Help icon. The Stop icon is used to shut the entire sprinkler irrigation system down immediately.

An ‘All Off’ Timer Override window allows the user to click on this window and manually shut the Microcontroller down immediately. The window is displayed in red when the system is in the manual shut down mode. This feature is also used to override the rain sensor and shut the system down whenever the user desires to.

There are fifteen Zone Number windows and Zone Name windows grouped and displayed together on the Control Panel. Each Zone Number is one of fifteen physical zones that are hard coded into the system. The current system supports up to 15 zones, but the proprietary software can be programmed to accept a greater number of zones. The zones can be a combination of either sprinkler zones or light zones. The sprinkler zones normally start from zone one, and light zones begin with zone 13, but this is software programmable option based on end user preferences. Depending on the layout, zones one through twelve could be sprinkler zones and 13 through 15 could be light zones.

While the host computer is connected to the Microcontroller, the user may review each zone's usage data displayed on the Control Panel such as: run time, gallons used, pump pressure/flow system time and power consumption. The Run Time window displays the elapsed time in minutes a zone has been running. The Gallons Used window displays the gallons of water used during the indicated run time of the zone. Pump Pressure and Pump Flow Rate are also monitored by the system. The Pump Pressure and Pump Flow Rate readings are sent to the host computer and displayed on the Control Panel. The Pump Pressure is monitored by the Microcontroller and displayed in the Pump Pressure window in pounds per square inch (PSI). The readings provide real time information on any changes where a low-pressure reading may indicate a break or an open line, and a high-pressure reading may indicate problems with a valve or valve circuits not operating properly. On residential or commercial applications that are not on a pump or well, this reading indicates the pressure and flow of the city or county water pressure. The Microcontroller also monitors the line flow rate or system flow rate. The gallons per minute (GPM) the system is using is displayed in the Pump Flow Rate window.

Electrical lighting such as pool lights, security lights, and landscape lights can be controlled by this system. The Light Power window indicates the power consumption in watts of the devices monitored. The system is capable of controlling multiple zones that can be divided up to control or manage any combination of lights or sprinklers. In this example, only one zone is used to control lights. The amount of power that is being consumed by the Light zones is continuously monitored by the system. The window is displayed in green (color may vary) when lights are operational.

A special Advanced Details tab is featured on the Control Panel to provide access to a password protected window that allows only authorized service personnel to set up and make changes to the advanced setup parameters. This window was designed for service personnel and the installation personnel who need to change advanced system settings. The Advanced Details screen also provides the ability to set or establish operating parameters of the system. Operating limits for water flow or electrical flow can be controlled by the limits specified in the Flow Light Power Limits window.

The features and advantages of the present invention are numerous. With respect to the controller unit, the following features and advantages can be readily ascertained: turn standard sprinkler valves on and off on 45 or more zones; turn standard electrical relays on and off which can in turn operate any electrical appliance; measure water flow through a pipe; measure electrical current; detect water leaks by detecting water flow rates outside of preset limits; detect burned out electrical appliances or other problems by detecting electrical current flow rates outside of preset limits; run a preset irrigation schedule on a 14 day cycle; run a preset irrigation schedule on an odd/even day cycle; record any flow rate failures electronically and report them at a later time; record scheduled irrigation events electronically and report them at a later time; record water quantity used during a scheduled irrigation event electronically and report it at a later time; operate landscape lighting on a preset schedule; communicate with a remote PC via a modem or direct RS232 connection; report real time water flow to a PC; report real time electrical current flow to a PC; call a PC via modem or direct RS232 connection whenever a flow rate failure occurs; report current zone status to a PC in real time; send or receive a scheduled list of events to or from a PC; keep current time and date; turn off a zone when a failure has occurred; call a pager service whenever a flow rate failure occurs; provide a stand-alone unit that can operate independently of a PC after it has been programmed; turn grow lights on and off via a preset schedule; 365 day scheduling to allow programming of a scheduled event to happen on any day of the year; storage for over 2000 scheduled events; rain sensor override switch allowing operation when rain sensor is engaged; controller saving of operation data electronically for later retrieval and analysis on a PC.

With respect to the software functionality, the following features and advantages can be readily ascertained: complete remote control of a controller unit; turn zones on and off in real time remotely with a single mouse click; unlimited number of remote controller units operated from a single PC; monitoring of pressure and flow rates in real time remotely; real time graph of pressure; real time graph of flow rates; override option to turn off all zones until further notice; zones identified by a descriptive name or number; Quick Schedule allows entry of a one-time schedule to be run at a given time; zone flow rates automatically calibrated remotely; real time display of zone run times; real time display of gallons used during a zone run; monitoring company can monitor several units and send repair crews when a failure occurs; simple graphical user interface; graphical display of zone schedules with each zone displayed in a different color; zone schedules created by a drag-and-drop process; schedules copied from one day to another; schedules read and written from/to a controller remotely; schedule run times increased or decreased by a percentage by clicking on a single button; schedule run times displayed by bars of varying lengths on a time graph; any zone scheduled to run at any time, independent of other zones; zone start and stop run times set by clicking on a single run time button, or by clicking up and down arrows to adjust the run time in minutes; schedules saved and retrieved from memory; Advanced Details screen allows access to raw data configuration data of controller; controllers contacted by clicking on a single icon at any time; connection closed at any time by clicking on a single icon; multiple independent schedules running on each zone card; light zone cards which allow on one more zones on simultaneously; each light zone run on an independent schedule; zone run times controlled by quantity of water used rather than time; zone run times controlled by inches of water covering a given areas; landscape maps displayed on PC screen showing real time zone status; PC network interface card allowing controller unit through a LAN.

Based on the foregoing, the present invention provides significant advantages over prior art irrigation controllers now in use. It should be understood that the examples and embodiments described herein are for illustrative purposes only and that various modifications or changes in light thereof will be suggested to persons skilled in the art and are to be included within the spirit and purview of this application.

1. In a water distribution network comprising a water source and at least one watering zone, a programmable water management distribution system comprising:
a) a meter device for measuring water flow interposed between said water source and said water distribution network;
b) at least one valve downstream from said meter device which operates to provide water to said water distribution network; and
c) a programable controller connected to said valve, said controller operating to open and close said valve in accordance with a predetermined schedule and wherein said controller is responsive to flow measurements of said meter device.

2. The programmable water management distribution system according to claim 1, wherein said meter comprises a venturi tube having an inlet section and a constricted throat.

3. The programmable water management distribution system according to claim 2, wherein said meter device further comprises at least one transducer, wherein said transducer is removably affixed to said venturi tube and in physical communication with the water traveling through said venturi tube, said transducer being connected to said controller.

4. The programmable water management distribution system according to claim 3, further comprising a leak detection means which operates to close said valve when the flow measurements of said meter device exceed a preset limit.

5. The programmable water management distribution system according to claim 3, wherein a first transducer is positioned within said constricted throat and a second transducer is positioned within said inlet chamber.

6. The programmable water management distribution system according to claim 1, wherein said controller is remotely programmable.

7. The programmable water management distribution system according to claim 1, further comprising a programming means for remotely programming said controller with said predetermined schedule.

8. The programmable water management distribution system according to claim 1, further comprising a programming means for continually monitoring the water flow to said zones from said flow measurements of said meter device.

9. The programmable water management distribution system according to claim 1, wherein said controller further comprises means for generating a water usage report.

10. The programmable water management distribution system according to claim 1, further comprising at least one zone of electrically operated devices and at least one switch, wherein said zones of electrically operated devices are connected to said programmable controller, such that said programmable controller turns on and off said electrical devices in accordance with a preprogrammed schedule.

11. The programmable water management distribution system according to claim 10, further comprising an electrical metering device, such that said electrical metering device measures electricity usage.

12. The programmable water management distribution system according to claim 1, further comprising a rain sensor connected to said programmable controller, such that when activated said rain sensor disables said at least one valve when rain is detected.

13. A programmable controller for controlling activation of an irrigation system comprising:
memory device for storing scheduling information for said irrigation system, said scheduling information provided by remote programming means; electrical circuitry for interfacing with and activating at least one irrigation valve for controlling water flow therethrough;
processor unit for signaling said electrical circuitry to activate said irrigation valve based upon said scheduling information; and
sensor device for detecting flow measurements of said irrigation system and providing said flow measurements to said processor unit to allow adjustments to or overriding of said scheduling information based on said measurements.

14. The programmable controller of claim 13 wherein said sensor device comprises a venturi tube.

15. A method of controlling a water management distribution system comprising a programmable remote system connected to a controller of a water distribution network, comprising the following steps:
a) receiving a watering schedule in said remote system;
b) transmitting said watering schedule to said controller;
c) controlling said distribution system in accordance with said schedule; and
d) real-time adjusting of said watering schedule by said controller based on external inputs to said controller.

16. The method of controlling a water management distribution system according to claim 15, further comprising the following steps;
a) storing a daily water usage;
b) calculating an average water usage from said daily water usage;
c) calculating an adjusted water flow rate; and
d) adjusting water flow rate in accordance with said calculations.

17. The method of controlling a water management distribution system according to claim 16, further comprising the following steps;
a) storing at least one flow rate preset limit;
b) comparing said adjusted flow rating to said flow rate preset limit; and
c) shutting down a zone when said adjusted flow rate is outside said flow rate limit.

18. An automatic shut-off system for a water supply line comprising:
a) a valve for opening and closing said water line;
b) control means for controlling said valve;
c) a venturi tube disposed within said water line having sensors for sensing a pressure change in said water line cause by flow in said water line;
d) means for sending a signal from said sensors to said control means indicative of flow;
e) means for comparing said signal with a preset limit;
f) means for selectively closing said valve should said signal exceed said preset limit.
